(19) United States
(12) Patent Application Publication
(10) Pub. No.: US 2014/0011972 A1
(43) Pub. Date: Jan. 9, 2014

(54) CARBOCATALYSTS FOR POLYMERIZATION

(71) Applicants: Christopher W. Bielawski, Austin, TX (US); Daniel R. Dreyer, Austin, TX (US)

(72) Inventors: Christopher W. Bielawski, Austin, TX (US); Daniel R. Dreyer, Austin, TX (US)

(73) Assignee: GRAPHEA, INC., Austin, TX (US)

(21) Appl. No.: 13/984,010

(22) PCT Filed: Feb. 7, 2012
(86) PCT No.: PCT/US12/24106

§ 371 Date: Sep. 19, 2013

Related U.S. Application Data
(60) Provisional application No. 61/440,574, filed on Feb. 8, 2011.
(60) Provisional application No. 61/487,551, filed on May 18, 2011.
(60) Provisional application No. 61/496,326, filed on Jun. 13, 2011.
(60) Provisional application No. 61/502,390, filed on Jun. 29, 2011.
(60) Provisional application No. 61/523,059, filed on Aug. 12, 2011.
(60) Provisional application No. 61/564,135, filed on Nov. 28, 2011.

(51) Int. Cl. C08F 4/32; C08G 61/10; C08G 63/82; C08G 69/04

(52) U.S. Cl. CPC C08F 4/32; C08G 69/04; C08G 61/10; C08G 63/823
USPC 526/204; 528/336; 528/214; 528/397; 528/355; 528/317

(57) ABSTRACT

Provided herein are novel processes for synthesis of polymers and/or polymer composites.

### CROSS-REFERENCE

This application claims the benefit of U.S. Provisional Application No. 61/440,574, filed Feb. 8, 2011, U.S. Provisional Application No. 61/487,551, filed May 18, 2011, U.S. Provisional Application No. 61/496,326, filed Jun. 13, 2011, U.S. Provisional Application No. 61/502,390, filed Jun. 29, 2011, U.S. Provisional Application No. 61/523,059, filed Aug. 12, 2011, and U.S. Provisional Application No. 61/564,135, filed Nov. 28, 2011, and each application is incorporated herein by reference in its entirety.

### STATEMENT AS TO FEDERALLY SPONSORED RESEARCH AND FUNDING

At least a portion of this invention was made with the support of the United States government under Contract number DMR-0907324 from the National Science Foundation. At least a portion of this invention was made using funding from the Robert A. Welch Foundation under Contract number F-1621.

### BACKGROUND OF THE INVENTION

Organic material transformations such as redox reactions, hydration reactions, dehydrogenation reactions, condensation reactions and the like are catalyzed by a variety of chemical catalysts. However, currently available catalysts and/or reaction methods have a number of drawbacks, such as expense, toxicity, environmental incompatibility, difficulty in separation from the reaction product, complex reaction conditions, lack of selectivity, lack of compatibility with functional groups, and inefficient catalysis.

The use of metal catalysts has various drawbacks, such as metal contamination of the resulting products. This is particularly a problem in industries where the product is intended for biological use or other uses sensitive to the presence of metals. Metal catalysts are also often not selective in oxidation reactions and many do not tolerate the presence of functional groups well.

### SUMMARY OF THE INVENTION

Described herein are methods and processes having broad synthetic utility for synthesis of polymers and/or polymer composites.

In one aspect, provided herein is a process for synthesis of a polymer, comprising:

(a) contacting monomers with a catalytically active carbocatalyst; and

(b) transforming the monomers with the aid of the catalytically active carbocatalyst to form a mixture of a polymer product and a spent or partially spent carbocatalyst.

In some embodiments, the catalytically active carbocatalyst is an oxidized form of graphite. In some embodiments, the catalytically active carbocatalyst is graphene oxide or graphite oxide.

In some embodiments, the catalytically active carbocatalyst is an oxidized carbon-containing material.

In some embodiments, the catalytically active carbocatalyst is characterized by one or more FT-IR features at about 3150 cm-1, 1685 cm-1, 1280 cm-1, or 1140 cm-1.

In some embodiments, the catalytically active carbocatalyst is a heterogenous catalyst.

In some embodiments, the catalytically active carbocatalyst provides a reaction solution pH which is neutral upon dispersion in a reaction mixture. In some embodiments, the catalytically active carbocatalyst provides a reaction solution pH which is acidic upon dispersion in a reaction mixture. In some embodiments, the catalytically active carbocatalyst provides a reaction solution pH which is basic upon dispersion in a reaction mixture.

In some embodiments, the catalytically active carbocatalyst is present on a solid support. In some embodiments, the catalytically active carbocatalyst is present within a solid support.

In some embodiments, the catalytically active carbocatalyst has a plurality of functional groups selected from a hydroxyl group, an alkyl group, an alkenyl group, an alkynyl group, an aryl group, epoxide group, peroxide group, peroxyacid group, aldehyde group, ketone group, ether group, carboxylic acid or carboxylate group, peroxide or hydroperoxide group, lactone group, thiolactone, lactam, thiolactam, quinone group, anhydride group, ester group, carbonate group, acetal group, hemiacetal group, ketal group, hemiketal group, amino, aminohydroxy, aminal, hemiaminal, carbamate, isocyanate, isothiocyanate, cyanamide, hydrazine, hydrazide, carbodiimide, oxime, oxime ether, N-heterocycle, N-oxide, hydroxylamine, hydrazine, semicarbazone, thiosemicarbazone, urea, isourea, thiourea, isothiourea, enamine, enol ether, aliphatic, aromatic, phenolic, thiol, thioether, thioester, dithioester, disulfide, sulfoxide, sulfone, sultone, sulfinic acid, sulfenic acid, sulfenic ester, sulfonic acid, sulfite, sulfate, sulfonate, sulfonamide, sulfonyl halide, thiocyanate, thiol, thial, S-heterocycle, silyl, trimethylsilyl, phosphine, phosphate, phosphoric acid amide, thiophosphate, thiophosphoric acid amide, phosphonate, phosphinite, phosphite, phosphate ester, phosphonate diester, phosphine oxide, amine, imine, amide, aliphatic amide, aromatic amide, halogen, chloro, iodo, fluoro, bromo, acyl halide, acyl fluoride, acyl chloride, acyl bromide, acyl iodide, acyl cyanide, acyl azide, ketene, alpha-beta unsaturated ester, alpha-beta unsaturated ketone, alpha-beta unsaturated aldehyde, anhydride, azide, diazo, diazonium, nitrate, nitrate ester, nitroso, nitrile, nitrite, orthoester group, orthocarbonate ester group, O-heterocycle, borane, boronic acid, boronic ester.

In some embodiments, the conversion is catalytic or stoichiometric with respect to the amount of catalytically active carbocatalyst.

In some embodiments, the process further comprises contacting the monomers with a co-catalyst. In some embodiments, the co-catalyst is an oxidation catalyst. In some embodiments, the co-catalyst is a zeolite.

In some embodiments, the process further comprises an additional oxidizing agent.

In some embodiments, the process comprises a solvent-free reaction.

In some embodiments, the process comprises one or more gaseous monomers in contact with a catalytically active carbocatalyst.

In some embodiments, for any process described above or below, the polymer is formed by condensation polymerization. In some embodiments, for any process described above or below, the polymer is formed by dehydrative polymerization. In some embodiments, for any process described above or below, the polymer is formed by dehydrohalongenation polymerization. In some embodiments, for any process described above or below, the polymer is formed by addition polymerization. In some embodiments, for any process described above or below, the polymer is formed by olefin polymerization. In some embodiments, for any process described above or below, the polymer is formed by ring opening polymerization. In some embodiments, for any process described above or below, the polymer is formed by cationic polymerization. In some embodiments, for any process described above or below, the polymer is formed by acid-catalyzed polymerization. In some embodiments, for any process described above or below, the polymer is formed by oxidative polymerization.

In some embodiments, the polymer product obtained from any process described above or below is further purified to obtain a polymer product which is substantially free of the spent carbocatalyst or partially spent carbocatalyst.

In some embodiments, for any process described above or below, the polymer product is a polymer composite. In some embodiments of such embodiments, the polymer composite comprises spent carbocatalyst or partially spent carbocatalyst. In some embodiments of such embodiments, the polymer composite is further compounded with one or more additional additives. In some embodiments, the additional additive is metastable graphene, unreacted monomer, a separate pre-formed polymer or a separate composite, or a combination thereof.

In some embodiments, for any process described above or herein, the monomers are the same. In some other embodiments, for any process described above or herein the monomers are not the same (e.g., the polymer product is a co-polymer).

Provided herein is a polymer made by any process described above or herein. In some embodiments, the polymer is a polyester, a polyamide, a polyolefin, a polyurethane, a polysiloxane, an epoxy, or a polycarbonate.

Also provided herein is a polymer composite made by any process described above or herein. In some embodiments, the polymer composite comprises a polymer selected from a polyester, a polyamide, a polyolefin, a polyurethane, a polysiloxane, an epoxy, and a polycarbonate.

In one aspect, provided herein is a process for condensation polymerization, comprising:

(a) contacting monomers with a catalytically active carbocatalyst; and

(b) transforming the monomers with the aid of the catalytically active carbocatalyst to form a mixture of a polymer product and a spent or partially spent carbocatalyst.

In one aspect, provided herein is a process for additive polymerization, comprising:

(a) contacting monomers with a catalytically active carbocatalyst; and

(b) transforming the monomers with the aid of the catalytically active carbocatalyst to form a mixture of a polymer product and a spent or partially spent carbocatalyst.

In one aspect, provided herein is a process for ring opening polymerization, comprising:

(a) contacting monomers with a catalytically active carbocatalyst; and

(b) transforming the monomers with the aid of the catalytically active carbocatalyst to form a mixture of a polymer product and a spent or partially spent carbocatalyst.

In one aspect, provided herein is a process for oxidative polymerization, comprising:

(a) contacting monomers with a catalytically active carbocatalyst; and

(b) transforming the monomers with the aid of the catalytically active carbocatalyst to form a mixture of a polymer product and a spent or partially spent carbocatalyst.

In one aspect, provided herein is a process for cationic polymerization, comprising:

(a) contacting monomers with a catalytically active carbocatalyst; and

(b) transforming the monomers with the aid of the catalytically active carbocatalyst to form a mixture of a polymer product and a spent or partially spent carbocatalyst.

In one aspect, provided herein is a process for dehydrative polymerization, comprising:

(a) contacting monomers with a catalytically active carbocatalyst; and

(b) transforming the monomers with the aid of the catalytically active carbocatalyst to form a mixture of a polymer product and a spent or partially spent carbocatalyst.

For any of the processes described above, in one embodiment the mixture is further modified (e.g., concentrated, filtered, purified or the like) such that the isolated product is substantially free of the spent or partially spent carbocatalyst. For any of the processes described above, in a different embodiment the mixture is further modified (e.g., concentrated, filtered, compounded, purified or the like) such that the isolated product is a polymer composite comprising a polymer and a carbocatalyst, spent carbocatalyst or partially spent carbocatalyst, or a combination thereof. In some of such embodiments, the composite is optionally further compounded as described herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of one graphene oxide or graphite oxide catalyst that may be used in methods of the disclosure.

FIG. 2 shows X-ray Photoelectron Spectroscopy (XPS) performed on samples of as-prepared graphite oxide.

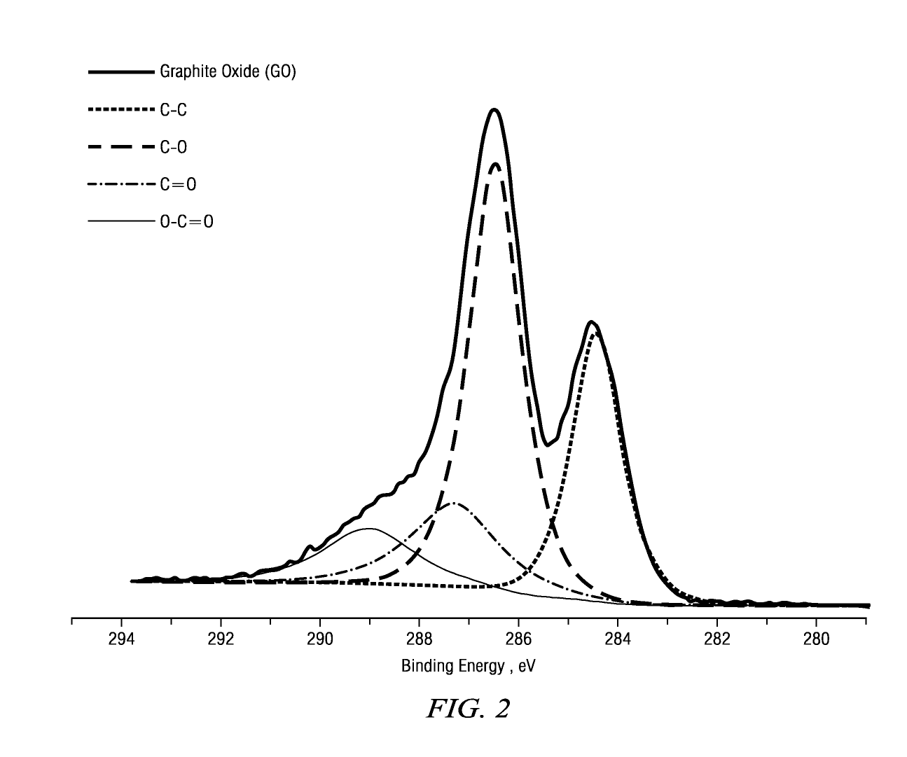

FIG. 3 (three panels) shows polymerization reactions using a graphene oxide or graphite oxide catalyst, according to an embodiment of the current disclosure. FIG. 3A shows an acid-catalyzed polymerization. FIG. 3B shows a dehydrative polymerization. FIG. 3C shows an oxidative polymerization.

FIG. 4 shows an example reaction scheme for polymerization reactions, using graphene oxide or graphite oxide, according to an embodiment of the current disclosure.

FIG. 5 schematically illustrates a system comprising a reactor having a carbocatalyst, according to an embodiment of the current disclosure.

### DETAILED DESCRIPTION OF THE INVENTION

Polymers are used in a wide range of industrial applications. Described herein are novel methods for synthesis of polymers comprising the use of carbocatalysts described herein.

Currently available catalysts and/or reaction methods for polymerizations have a number of drawbacks, such as expense, toxicity, environmental incompatibility, difficulty in separation from the reaction product, complex reaction conditions, lack of selectivity, lack of compatibility with functional groups, variable polydispersity and/or molecular weight.

The methods of polymer synthesis described herein allow for synthesis of polymers and polymer composites with improved electronic, optical, mechanical, barrier and/or thermal properties. In some instances the methods of polymerization described herein provide better polymerization yields, reduced contamination with side products and/or reactants (e.g., monomers) and/or reagents, lower polydispersity indices and/or improved control of molecular weights or chain lengths or chain branching in polymers. In further instances, the methods of polymer synthesis described herein are suitable for design of polymers of complex architectures, such as linear block copolymers, cyclic, comb-like, star, brush polymers and/or dendrimers.

In some instances, the carbocatalyst-mediated methods of polymer synthesis described herein yield polymers or polymer composites with improved electronic properties compared to other methods of synthesis as described in, for example, Example 10. In some of such embodiments, the polymer or polymer composite product has substantially uniform reduction across the polymer and enhances electronic properties of the polymer. In some instances, the carbocatalyst-mediated methods of polymer synthesis described herein yield polymers or polymer composites with improved mechanical and/or thermal properties compared to other methods of synthesis as described in, for example, Example 6. In some of such embodiments, the polymer or polymer composite product is substantially free of unreacted monomers and/or has lower polydispersity (e.g., substantially uniform chain lengths).

The carbocatalyst-mediated reactions described herein facilitate polymer syntheses in a number of different ways. For example, in one case, polymers are formed by an addition reaction, where many monomers bond together via rearrangement of bonds without the loss of any atom or molecule. For instance, Examples 7-10 describe certain olefin polymerizations.

In another instance, a polymer is formed by a condensation reaction where a molecule, e.g. water, is lost during each monomer condensation. For instance, Example 6 describes certain dehydrative polymerizations.

In yet another instance, a polymer is synthesized by ring opening polymerization (e.g., poly[ethylene oxide] is formed by opening ethylene oxide rings). For instance, Examples 1114 describe certain ring opening polymerizations.

In any of the above embodiments, the polymer product is optionally further compounded to a polymer composite comprising graphene, GO and/or other carbon or non-carbon fillers as described herein. For instance, Examples 6-14 describe properties of certain polymer composites.

### DEFINITIONS

The term “catalyst,” as used herein, refers to substance or species that facilitates one or more chemical reactions. A catalyst includes one or more reactive active sites for facilitating a chemical reaction, such as, for example, surface moieties (e.g., OH groups, epoxides, aldehydes, carboxylic acids). The term catalyst includes a graphene oxide, graphite oxide, or other carbon and oxygen-containing material that facilitates a chemical reaction, such as an oxidation reaction or polymerization reaction. In some situations, the catalyst is incorporated into the reaction product and/or byproduct. As one example, a graphene or graphite oxide catalyst for facilitating a polymerization reaction is at least partially incorporated into a polymer matrix of the polymer formed in the reaction.

The term “carbocatalyst,” as used herein, refers to a catalyst that includes graphite, graphite oxide, graphene, graphene oxide, or closely related carbon materials for the transformation or synthesis of organic or inorganic substrates, or the polymerization of monomeric subunits (also “monomers” herein). In some embodiments a carbocatalyst as used herein comprises carbon materials like graphite, graphite oxide, graphene, graphene oxide activated carbon, or a combination thereof. In some embodiments a carbocatalyst as used herein comprises carbon materials like graphite, graphite oxide, graphene, graphene oxide activated carbon, charcoal, carbon nanotubes, and/or fullerenes, or a combination thereof.

The term “spent catalyst” or “spent carbocatalyst,” as used herein, refers to a catalyst that has been exposed to a reactant to generate a product. In some situations, a spent catalyst is incapable of facilitating a chemical reaction. A spent catalyst has reduced activity with respect to a freshly generated catalyst (also “fresh catalyst” herein). The spent catalyst is partially or wholly deactivated or spent. In some cases, such reduced activity is ascribed to a decrease in the number of reactive active sites.

The term “heterogeneous catalyst” or “heterogeneous carbocatalyst,” as used herein, refers to a solid-phase species configured to facilitate a chemical transformation. In heterogeneous catalysis, the phase of the heterogeneous catalyst generally differs from the phase of the reactants(s). A heterogeneous catalyst includes a catalytically active material on a solid support. In some cases the support is catalytically active or inactive. In some situations, the catalytically active material and the solid support is collectively referred to as a “heterogeneous catalyst” (or “catalyst”).

The term “solid support,” as used herein, refers to a support structure for holding or supporting a catalytically active material, such as a catalyst (e.g., carbocatalyst). In some cases, a solid support does not facilitate a chemical reaction. However, in other cases the solid support takes part in a chemical reaction.

The term “nascent catalyst” or “nascent carbocatalyst,” as used herein, refers to a substance or material that is used to form a catalyst. A nascent catalyst is characterized as a species that has the potential for acting as a catalyst, such as, upon additional processing or chemical and/or physical modification or transformation.

The term “surface,” as used herein, refers to the boundary between a liquid and a solid, a gas and a solid, a solid and a solid, or a liquid and a gas. A species on a surface has decreased degrees of freedom with respect to the species in the liquid, solid or gas phase.

The term “graphene oxide,” as used herein, refers to catalytically active graphene oxide.

The term “graphite oxide,” as used herein, refers to catalytically active graphite oxide.

The term “polymer” refers to covalently linked monomers. The number of covalently linked monomers comprised in the polymer is variable and is included within the scope of embodiments presented herein. In one embodiment, a polymer may be an oligomer. In another embodiment, a polymer comprises unlimited monomers. In further embodiments, a polymer may be a dimer, a trimer, a tetramer or the like. In further embodiments, a polymer is at least a 25-mer, a 50-mer, or a 100-mer. In one embodiment, a polymer comprises the same monomers. In another embodiment, a polymer comprises different monomers (e.g., a co-polymer). The different monomers may be present in the co-polymer in any sequence (e.g., repeating, random, tandem repeat, and the like). In a further embodiment, the term polymer encompasses block copolymers.

The term “polymer composite” refers to a material comprising more than one component wherein at least one component is a polymer as described above and herein. In one embodiment, a polymer composite described herein includes a polymer as described herein, and one or more additional components which are dispersed in the polymer matrix.

For example, in one embodiment, a polymer composite described herein comprises a polymer product obtained from a reaction described herein along with the carbocatalyst dispersed within the polymer matrix. In another embodiment, a polymer composite described herein includes a polymer as described herein, and an additional component which is a spent carbocatalyst as described herein. In yet another embodiment, a polymer composite described herein includes a polymer as described above, and an additional component which is a partially spent carbocatalyst described herein.

In further embodiments, a polymer composite described herein includes a polymer or polymer composite as described above, and further additional component such as, for example, graphene, metastable graphene, carbon particles, a zeolite, a metal, an additional polymer or co-polymer, and the like.

The term “electron withdrawing group” refers to a chemical substituent that modifies the electrostatic forces acting on a nearby chemical reaction center by withdrawing negative charge from that chemical reaction center. Thus, electron withdrawing groups draw electrons away from a reaction center. Examples include and are not limited to nitro, halo (e.g., fluoro, chloro), haloalkyl (e.g., trifluoromethyl), ketones, esters, aldehydes and the like.

The term “electron donating group” refers to a chemical substituent that modifies the electrostatic forces acting on a nearby chemical reaction center by increasing negative charge at that chemical reaction center. Thus, electron donating groups increase electron density at a reaction center. Examples include but are not limited to alkyl, alkoxy, amino substituents.

Recognized herein are various limitations associated with current commercially-available methods catalyzing chemical reactions. For instance, while transition metal-based catalysts may provide reactions rates that are commercially feasible, the use of metal catalysts has various drawbacks, such as metal contamination of the resulting products. This is particularly problematic in industries where the product is intended for health or biological use, or other uses sensitive to the presence of metals. Another drawback of metal catalysts is that metal catalysts are typically not selective in oxidation reactions and may not tolerate the presence of functional groups in the reactants. As another example to illustrate the drawbacks of metal-based catalysts recognized herein, transition metal-based catalysts may be expensive to manufacture and processes employing such catalysts may have considerable startup and maintenance costs.

Accordingly there is a need for broad-spectrum catalysts that overcome one or more drawbacks of existing catalysts and that are able to catalyze a variety of chemical reactions using a wide range of initial reactants or starting materials.

Described herein are processes for organic transformations involving the use of carbocatalysts that combine the benefits of a metal-free synthesis along with the convenience of heterogeneous work up. Advantageously, the versatile carbocatalysts and processes utilizing such carbocatalysts that are described herein are applicable to a variety of organic reactions including and not limited to polymerizations that involve oxidations, reductions, dehydrogenations, hydrations, additive reactions (e.g., alkane or alkene coupling) and/or condensations (e.g. aldol reactions), and the like. Methods of the current disclosure may also have applications in varied fields such as pharmaceuticals, electro-organic materials, aerospace applications and the like.

The ability of various carbon-based materials to catalyze the extremely wide number of possible chemical polymerization reactions has hitherto not been explored in detail. To date such efforts have relied on exploitation of the relatively high surface areas intrinsic to carbon-based materials to enhance the activity of transition metal based catalysts. For example, metal catalysts have been placed on graphene-based materials to take advantage of the high surface area of such materials and to enhance the activities of the transition metal-based catalysts. In some instances, when metals such as Palladium (Pd) and Platinum (Pt) have been placed on graphene oxide materials to form catalysts, the catalytic activity is attributable to Pt or Pd, or a combination of the metal and graphene oxide materials. In contrast, the carbocatalysts described herein are free of transition metals such as Pt or Pd and the reactions are catalyzed by the carbocatalyst. For example, Ziegler-Natta catalysts are used in polymerization reactions. However such Titanium or Vanadium based catalysts increase cost of goods in manufacturing processes.

The carbocatalysts, and processes involving the use of carbocatalysts, which are described herein are useful for the synthesis of a large number of industrially and commercially important chemicals that would otherwise be difficult or prohibitively expensive to produce. Additionally, some useful chemical reactions involving organic materials have no available catalysts and are therefore unduly slow or costly. In some embodiments, the carbocatalysts provided herein provide access to such previously intractable chemistries. The broad-spectrum catalysts described herein are able to catalyze a variety of chemical reactions using a variety of initial products (starting materials) and provide a non-toxic alternative to other catalysts and/or reactions. The broad spectrum catalyst and methods of using such catalysts that are provided herein overcome one or more drawbacks of existing catalysts and/or processes.

### Carbocatalysts

In an aspect, carbon-containing catalysts described herein are configured to facilitate a chemical reaction, such as a polymerization reaction (e.g., an additive polymerization, a condensation polymerization (e.g., a dehydrative polymerization), a ring opening polymerization, a cationic polymerization, an oxidative polymerization, a dehydrohalogenation polymerization, and the like). In some embodiments, carbon-containing catalysts are catalytically-active graphene oxide, graphite oxide or other carbon and oxygen-containing catalysts, including heterogeneous catalysts. In some situations, a carbon-containing catalyst is a graphene oxide catalyst or a graphite oxide catalyst.

Methods of Preparing Catalytically Active Carbocatalysts

In one aspect, a carbocatalyst suitable for reactions described herein is an oxidized form of graphite, e.g., a graphene or graphite oxide based catalyst. Graphene or graphite oxide used as a catalyst in the present disclosure is produced using known methods. For example, graphene or graphite oxide is produced by the oxidation of graphite using KMnO₄ and NaNO₃ in concentrated sulfuric acid in concentrated sulfuric acid as described in W. S. Hummer Jr. R. E. Offeman, J. Am. Chem. Soc. 80: 1339 (1958) and A. Lerf, et al. J. Phys Chem. B 102: 4477-4482 (1998), both incorporated in material part by reference herein. Graphene or graphite oxide may also be produced by the oxidation of graphite using NaClO₃ in H₂SO₄ and fuming HNO₃ as described in L. Staudenmaier, Ber. Dtsch. Chem. Ges. 31: 1481-1487 (1898); L. Stuadenmaier, Ber. Dtsch. Chem. Ges. 32:1394-1399 (1899); T. Nakajima, et al. Carbon 44: 537-538 (2006), all incorporated in material part by reference herein. Graphene or graphite oxide may also be prepared by a Brodie reaction.

In some embodiments, a method for forming a catalytically-active graphene oxide or catalytically-active graphite oxide catalyst from a nascent catalyst comprises providing the nascent catalyst to a reaction chamber (or “reaction vessel”), the nascent catalyst comprising graphene or graphite on a solid support. Next, the nascent catalyst is heated in the reaction chamber to an elevated temperature. The nascent catalyst is then contacted with a chemical oxidant.

In some embodiments, the chemical oxidant includes at least one or more materials selected from the group consisting of potassium permanganate, hydrogen peroxide, organic peroxides, peroxy acids, ruthenium-containing species (e.g., tetrapropylammonium perruthenate or other perruthenates), lead-containing species (e.g., lead tetraacetate), chromium-containing species (e.g., chromium oxides or chromic acids), iodine-containing species (e.g., periodates), sulfur-containing oxidants (e.g., potassium peroxymonosulfate or sulfur dioxide), molecular oxygen, ozone, chlorine-containing species (e.g., chlorates or perchlorates or hypochlorites), sodium perborate, nitrogen-containing species (e.g., nitrous oxide or dinitrogen tetraoxide), silver containing species (e.g., silver oxide), osmium containing species (e.g., osmium tetraoxide), 2,2′-dipyridyldisulfide, cerium-containing species (e.g., ammonium cerium nitrate), benzoquinone, Dess Martin periodinane, meta-chloroperbenzoic acid, molybdenum containing species (e.g., molybdenum oxides), N-oxides (e.g., pyridine N-oxide), vanadium-containing species (e.g., vanadium oxides), (2,2,6,6-tetramethylpiperidin-1-yl)oxidanyl (TEMPO), or iron-containing species (e.g., potassium ferricyanide).

In other embodiments, the chemical oxidant is a plasma excited species of an oxygen-containing chemical. In an example, the chemical oxidant includes plasma-excited species of O₂, H₂O₂, NO, NO₂, or other chemical oxidants. In such a case, the nascent catalyst in the reaction chamber is contacted with plasma excited species of the oxygen-containing chemical continuously, such as for a predetermined period of time of at least about 0.01 seconds, or 0.1 seconds, or 1 second, or 10 seconds, or 30 seconds, or 1 minute, or 5 minutes, or 10 minutes, or 15 minutes, or 20 minutes, or 30 minutes, or 1 hour, or 2 hours, or 3 hours, or 4 hours, or 5 hours, or 6 hours, or 12 hours, or 1 day, or 2 days, or 3 days, or 4 days, or 5 days, or 6 days, or 1 week, or 2 weeks, or 3 weeks, or 1 month, or 2 months, or 3 months, or 4 months, or 5 months, or 6 months. Alternatively, the nascent catalyst in the reaction chamber is contacted with plasma excites species of the oxygen-containing chemical in pulses, such as pulses having a duration of at least about 0.1 seconds, or 1 second, or 10 seconds, or 30 seconds, or 1 minute, or 10 minutes, or 30 minutes, or 1 hour, or 2 hours, or 3 hours, or 4 hours, or 5 hours, or 6 hours, or 12 hours, or 1 day, or 2 days, or 3 days, or 4 days, or 5 days, or 6 days, or 1 week, or 2 weeks, or 3 weeks, or 1 month, or 2 months, or 3 months, or 4 months, or 5 months, or 6 months. In some situations, the nascent catalyst is exposed to the chemical oxidant for a time period between about 0.1 seconds and 100 days.

In some situations, the nascent catalyst is heated during exposure to the chemical oxidant. In an example, the nascent catalyst is heated at a temperature between about 20° C. and 3000° C., or 20° C. and 2000° C., or about 100° C. and 2000° C.

Alternatively, a method for forming a catalytically-active graphene oxide or catalytically-active graphite oxide catalyst from a nascent catalyst includes providing a nascent catalyst comprising graphene or graphite to a reaction chamber. The reaction chamber has a holder or susceptor for holding one or more nascent catalysts. Next, the nascent catalyst is contacted with one or more acids. In some cases, the one or more acids include sulfuric acid. In some cases, the nascent catalyst is pretreated with potassium persulfate before contacting the nascent catalyst with the one or more acids. Next, the nascent catalyst is contacted with a chemical oxidant. Next, the nascent catalyst is contacted with hydrogen peroxide.

As another alternative, a method for forming a catalytically-active graphene oxide or catalytically-active graphite oxide catalyst from a nascent catalyst includes providing a nascent catalyst comprising graphene or graphite to a reaction chamber. Next, the nascent catalyst is contacted with one or more acids. In some cases, the nascent catalyst is pretreated with potassium persulfate before the nascent catalyst is contacted with the one or more acids. In some cases, the one or more acids include sulfuric acid and nitric acid. The nascent catalyst is then contacted with sodium chlorate, potassium chlorate and/or potassium perchlorate.

In some embodiments, a method for forming a carbocatalyst comprises providing a carbon-containing material in a reaction chamber and contacting the carbon-containing material in the reaction chamber with an oxidizing chemical (also “chemical oxidant” herein) for a predetermined period of time until the carbon-to-oxygen ratio of the carbon-containing material is less than or equal to about 1,000,000 to 1. In some cases, the ratio is determined via elemental analysis, such as XPS. In some embodiments, the time sufficient to achieve such carbon-to-oxygen ratio is at least about 0.1 seconds, or 1 second, or 10 seconds, or 30 seconds, or 1 minute, or 10 minutes, or 30 minutes, or 1 hour, or 2 hours, or 3 hours, or 4 hours, or 5 hours, or 6 hours, or 12 hours, or 1 day, or 2 days, or 3 days, or 4 days, or 5 days, or 6 days, or 1 week, or 2 weeks, or 3 weeks, or 1 month, or 2 months, or 3 months, or 4 months, or 5 months, or 6 months. In some cases, the carbon-containing material is contacted with the chemical oxidant until the carbon-to-oxygen ratio, as determined by elemental analysis, is less than or equal to about 500,000 to 1, or 100,000 to 1, or 50,000 to 1, or 10,000 to 1, or 5,000 to 1, or 1,000 to 1, or 500 to 1, or 100 to 1, or 50 to 1, or 10 to 1, or 5 to 1, or 1 to 1.

As an alternative, a method for forming oxidized and catalytically-active graphite or oxidized and catalytically-active graphene comprises providing graphite or graphene in a reaction chamber and contacting the graphite or graphene with an oxidizing chemical until an infrared spectroscopy spectrum of the graphite or graphene exhibits one or more FT-IR features at about 3150 cm⁻¹, 1685 cm⁻¹, 1280 cm⁻¹, or 1140 cm⁻¹.

In some embodiments, methods for regenerating a spent catalyst, such as a carbocatalyst, include providing the spent catalyst in a reaction chamber or vessel and contacting the spent catalyst with a chemical oxidant. In some cases, the chemical oxidant includes one or more material selected from the group above. In other cases, the chemical oxidant is a plasma excited species of an oxygen-containing chemical. In an example, the chemical oxidant includes plasma-excited species of O₂, H₂O₂, NO, NO₂, or other chemical oxidants. In some embodiments, the spent catalyst is contacted with the chemical oxidant continuously or in pulses, as described above. Contacting the spent catalyst with the chemical oxidant produces a carbocatalyst having a catalytically active material. In an example, contacting a spent catalyst covered with graphene or graphite (or other carbon-containing and oxygen deficient material) forms a layer of catalytically-active graphene oxide or graphite oxide.

Also contemplated with the scope of the present disclosure are other methods of preparation of catalytically active graphene or graphite oxide as described in PCT International Application PCT/US2011/38327 which disclosure is incorporated herein by reference.

An advantage of catalytically active graphene or graphite oxide catalyzed reactions described herein is that the carbocatalyst is heterogeneous, i.e. it does not dissolve in the reaction mixture. Many starting materials, such as alcohols, aldehydes, alkynes, methyl ketones, olefins, methyl benzenes, thiols, and disubstituted methylenes, and their reaction products are soluble in a wide range of organic solvents. In chemical reactions comprising such dissolved starting materials, the graphene or graphite oxide remains as a suspended solid throughout the chemical reaction. In some of the aforementioned methods, the graphene or graphite oxide is removed from the reaction product using simple mechanical methods, such as filtration, centrifugation, sedimentation, or other appropriate mechanical separation techniques, eliminating the need for more complicated techniques such as chromatography or distillation to remove the catalyst.

Following a catalytic reaction, the graphene oxide or graphite oxide is in a different chemical form or in the same chemical form. For example, in one embodiment, reactions described herein result in slow reduction or deoxygenation of the graphene oxide or graphite oxide and loss of functional groups. This altered graphene oxide or graphite oxide remaining after catalysis is put to other uses, or it is regenerated. For example, following the catalytic reaction, the graphene or graphite oxide is in a reduced form. This material is very similar to graphene or graphite and may simply be used for graphene or graphite purposes. For example, reduced graphene oxide is used in energy storage devices or field effect transistors. Alternatively, the reduced graphene or graphite oxide is reoxidized to regenerate the graphene or graphite oxide catalyst. In a further embodiment, following a reaction, graphene or graphite oxide used in the reaction is regenerated in situ and is in the same form as at the start of the reaction. Reoxidation methods are the same as those used to generate the graphene or graphite oxide catalyst originally, such as a Hummers, Staudenmaier, or Brodie oxidation. Thus the carbocatalysts described herein provide an economical alternative to metal based catalysts.

In some embodiments of the invention, carbocatalysts are described that are configured for use with oxidation and/or polymerization reactions. Such carbocatalysts enable reaction rates up to and even exceeding that of transition metal-based catalysts, but reduce, if not eliminate, the contamination issues associated with the use of transition metal-based catalysts.

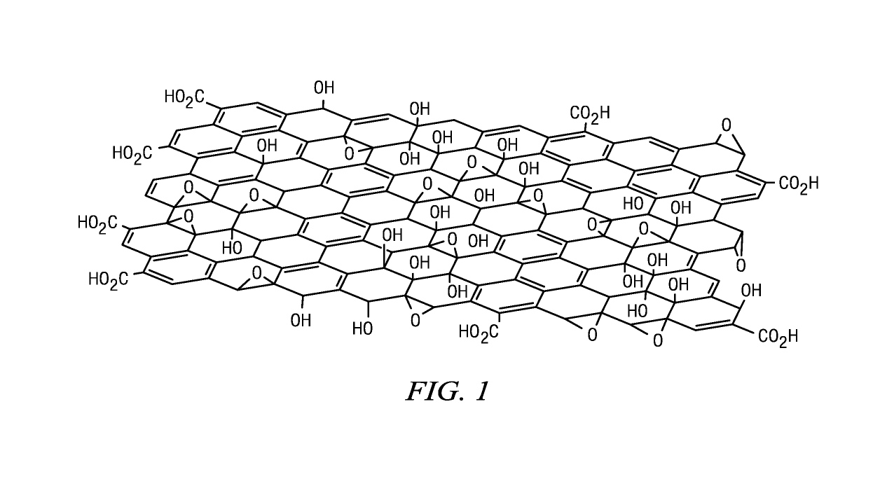

In one embodiment, a carbocatalyst used as a catalyst for any transformation described herein is catalytically active graphene or graphite oxide which comprises one or more oxygen-containing functionalities. An example graphene or graphite oxide catalyst is shown in FIG. 1. In specific embodiments, a graphene or graphite oxide based carbocatalyst described herein contains one or more of alcohols, epoxides, or carboxylic acids. In some situations, at least some of the oxygen-containing functional groups is used to oxidize organic species, such as alkenes and alkynes, or used to polymerize monomeric subunits (also “monomers” herein). In other cases, oxygen is used as a terminal oxidant. Various embodiments of the invention describe carbocatalysts having graphene oxide at various compositions, concentrations and islands shapes, coverage and adsorption locations.

Also contemplated with the scope of the present disclosure are variations of catalytically active graphene or graphite oxide, including variations in island shapes, coverage and/or adsorption locations, as described in co-pending PCT International Application PCT/US2011/38334 which disclosure is incorporated herein by reference.

Carbon-containing catalysts provided herein include unsupported catalytically-active graphene or catalytically-active graphite oxide, as well as graphene or graphite oxide on a solid support, such as a carbon-containing solid support or metal-containing solid support (e.g., TiO₂, Al₂O₃). In alternate embodiments, a solid support is a polymer with a catalytically active graphite oxide or graphene oxide dispersed in the polymer. In some embodiments, catalysts are provided having catalytically-active graphene oxide and/or catalytically-active graphite oxide on a solid support. Examples of such solid supports include carbon nitride, boron nitride, boron-carbon nitride and the like. In other embodiments, catalysts are provided having a catalytically-active carbon and oxygen-containing material and a co-catalyst such as carbon nitride, boron nitride, boron-carbon nitride and the like.

In further embodiments, carbon-containing catalysts provided herein include unsupported catalytically-active graphene or catalytically-active graphite oxide, as well as graphene or graphite oxide within a solid support, such as a zeolite, a polymer and/or metal-containing solid support (e.g., TiO₂, Al₂O₃). In some embodiments, catalysts are provided having catalytically-active graphene oxide and/or catalytically-active graphite oxide within a polymer support. In further embodiments, catalysts are provided having catalytically-active graphene oxide and/or catalytically-active graphite oxide within an amorphous solid, e.g., activated charcoal, coal fly ash, bio ash or pumice. In other embodiments, catalysts are provided having a catalytically-active carbon and oxygen-containing material and a co-catalyst such as carbon nitride, boron nitride, boron-carbon nitride and the like.

Metal Content

In some embodiments, a heterogeneous catalytically-active graphene oxide or graphite oxide catalyst (or other carbon and oxygen-containing catalyst, or a carbocatalyst) is substantially free of metal, particularly transition metal. In some cases, the heterogeneous catalyst has a substantially low metal (e.g., transition metal) concentration of metals selected from the group consisting of W, Fe, Ta, Ni, Au, Ag, Rh, Ru, Pd, Pt, Ir, Co, Mn, Os, Zr, Zn, Mo, Re, Cu, Cr, V, Ti and Nb. In an embodiment, the heterogeneous catalyst has a transition metal concentration that is less than or equal to about 50 part per million, about 20 part per million, about 10 part per million, about 5 part per million, about 1 part per million (“ppm”), or 0.5 ppm, or 0.1 ppm, or 0.06 ppm, or 0.01 ppm, or 0.001 ppm, or 0.0001 ppm, or 0.00001 ppm as measured by atomic absorption spectroscopy or mass spectrometry (e.g., inductively coupled plasma mass spectrometry, or “ICP-MS”). In another embodiment, the heterogeneous catalyst has a metal content (mole %) that is less than about 0.0001%, or less than about 0.000001%, or less than about 0.0000001%.

In some cases, a heterogeneous catalytically-active graphene oxide or graphite oxide catalyst (or other carbon and oxygen-containing catalyst) has a substantially low manganese content. In one example the particles have a manganese content that is less than about 1 ppm, or 0.5 ppm, or 0.1 ppm, or 0.06 ppm, or 0.01 ppm, or 0.001 ppm, or 0.0001 ppm, or 0.00001 ppm as measured by atomic absorption spectroscopy or mass spectrometry (e.g., inductively coupled plasma mass spectrometry, or “ICP-MS”).

In some situations, catalysts provided herein have a certain level of transition metal content. As an example, a carbocatalyst suitable for any reaction described herein includes graphene oxide or graphite oxide and has a transition metal content between about 1 part per million and about 50% by weight of the catalyst. In some cases, the transition metal content of the carbocatalyst is between about 1 part per million and about 25% by weight of the catalyst, or between about 1 part per million and about 10% by weight of the catalyst, or between about 1 part per million and about 5% by weight of the catalyst, or between about 1 part per million and about 1% by weight of the catalyst, or between about 10 part per million and about 50% by weight of the catalyst, or between about 100 part per million and about 50% by weight of the catalyst, or between about 1000 part per million and about 50% by weight of the catalyst, or between about 10 part per million and about 25% by weight of the catalyst, or between about 100 part per million and about 25% by weight of the catalyst, or between about 1000 part per million and about 25% by weight of the catalyst, or between about 10 part per million and about 10% by weight of the catalyst, or between about 100 part per million and about 10% by weight of the catalyst, or between about 1000 part per million and about 10% by weight of the catalyst, or between about 10 part per million and about 5% by weight of the catalyst, or between about 100 part per million and about 5% by weight of the catalyst, or between about 1000 part per million and about 5% by weight of the catalyst, or between about 10 part per million and about 1% by weight of the catalyst, or between about 100 part per million and about 1% by weight of the catalyst, or between about 1000 part per million and about 1% by weight of the catalyst.

Accordingly, in some other embodiments provided herein is a carbocatalyst, comprising catalytically-active graphene oxide or catalytically-active graphite oxide, the carbocatalyst having a transition metal content of between about 1 part per million and about 50% by weight of the carbocatalystcatalyst. In some embodiments, the metal is one or more transition metal selected from the group consisting of W, Fe, Ta, Ni, Au, Ag, Rh, Ru, Pd, Pt, Ir, Co, Mn, Os, Zr, Zn, Mo, Re, Cu, Cr, V, Ti and Nb. In certain embodiments, the carbocatalyst has a transition metal content of between about 1 part per million and about 25% by weight of the catalyst. In some embodiments, the carbocatalyst has a transition metal content of between about 1 part per million and about 5% by weight of the catalyst. In certain embodiments, the carbocatalyst has a transition metal content of between about 1 part per million and about 100 part per million.

In some situations, the transition metal content of the carbocatalyst is determined by atomic absorption spectroscopy (AAS) or other elemental analysis technique, such as x-ray photoelectron spectroscopy (XPS), or mass spectrometry (e.g., inductively coupled plasma mass spectrometry, or “ICP-MS”).

In some embodiments, the carbocatalyst has a low concentration of transition metals selected from the group consisting of W, Fe, Ta, Ni, Au, Ag, Rh, Ru, Pd, Pt, Ir, Co, Mn, Os, Zr, Zn, Mo, Re, Cu, Cr, V, Ti and Nb. In some embodiments, a carbocatalyst has a metal content (mole %) that is more than about 0.0001%, and up to about 50 mole % of the total weight of the catalyst, or more than about 0.001%, and up to about 50 mole % of the total weight of the catalyst, more than about 0.01%, and up to about 50 mole % of the total weight of the catalyst, more than about 0.1%, and up to about 50 mole % of the total weight of the catalyst, more than about 0.0001%, and up to about 25 mole % of the total weight of the catalyst, or more than about 0.001%, and up to about 25 mole % of the total weight of the catalyst, more than about 0.01%, and up to about 25 mole % of the total weight of the catalyst, more than about 0.1%, and up to about 25 mole % of the total weight of the catalyst, more than about 0.0001%, and up to about 10 mole % of the total weight of the catalyst, or more than about 0.001%, and up to about 10 mole % of the total weight of the catalyst, more than about 0.01%, and up to about 10 mole % of the total weight of the catalyst, more than about 0.1%, and up to about 10 mole % of the total weight of the catalyst, more than about 0.0001%, and up to about 5 mole % of the total weight of the catalyst, or more than about 0.001%, and up to about 5 mole % of the total weight of the catalyst, more than about 0.01%, and up to about 5 mole % of the total weight of the catalyst, more than about 0.1%, and up to about 5 mole % of the total weight of the catalyst. more than about 0.0001%, and up to about 1 mole % of the total weight of the catalyst, or more than about 0.001%, and up to about 1 mole % of the total weight of the catalyst, more than about 0.01%, and up to about 1 mole % of the total weight of the catalyst, more than about 0.1%, and up to about 1 mole % of the total weight of the catalyst.

Surface

In some embodiments, a non-transition metal catalyst having catalytically-active graphene oxide or graphite oxide has a surface that is configured to come in contact with a reactant, such as a hydrocarbon for oxidation or monomeric subunits for polymerization. In some cases, the catalyst has a surface that is terminated by one or more of hydrogen peroxide, hydroxyl groups (OH), epoxide groups, aldehyde groups, or carboxylic acid group. In an embodiment, the catalyst has a surface that includes one or more species (or “surface moieties”) selected from the group consisting of hydroxyl group, alkyl group, aryl group, alkenyl group, alkynyl group, epoxide group, peroxide group, peroxyacid group, aldehyde group, ketone group, ether group, carboxylic acid or carboxylate group, peroxide or hydroperoxide group, lactone group, thiolactone, lactam, thiolactam, quinone group, anhydride group, ester group, carbonate group, acetal group, hemiacetal group, ketal group, hemiketal group, amino, aminohydroxy, aminal, hemiaminal, carbamate, isocyanate, isothiocyanate, cyanamide, hydrazine, hydrazide, carbodiimide, oxime, oxime ether, N-heterocycle, N-oxide, hydroxylamine, hydrazine, semicarbazone, thiosemicarbazone, urea, isourea, thiourea, isothiourea, enamine, enol ether, aliphatic, aromatic, phenolic, thiol, thioether, thioester, dithioester, disulfide, sulfoxide, sulfone, sultone, sulfinic acid, sulfenic acid, sulfenic ester, sulfonic acid, sulfite, sulfate, sulfonate, sulfonamide, sulfonyl halide, thiocyanate, thiol, thial, S-heterocycle, silyl, trimethylsilyl, phosphine, phosphate, phosphoric acid amide, thiophosphate, thiophosphoric acid amide, phosphonate, phosphinite, phosphite, phosphate ester, phosphonate diester, phosphine oxide, amine, imine, amide, aliphatic amide, aromatic amide, halogen, chloro, iodo, fluoro, bromo, acyl halide, acyl fluoride, acyl chloride, acyl bromide, acyl iodide, acyl cyanide, acyl azide, ketene, alpha-beta unsaturated ester, alpha-beta unsaturated ketone, alpha-beta unsaturated aldehyde, anhydride, azide, diazo, diazonium, nitrate, nitrate ester, nitroso, nitrile, nitrite, orthoester group, orthocarbonate ester group, O-heterocycle, borane, boronic acid and boronic ester. In an example, such surface moieties are disposed on the surface at various reactive active sites of the catalyst.

Carbon Content

In some embodiments, a catalytically-active graphene oxide or graphite oxide catalyst (or other carbon and oxygen-containing catalyst) has a carbon content (mole %) of at least about 25%, or 30%, or 35%, or 40%, or 45%, or 50%, or 55%, or 60%, or 65%, or 70%, or 75%, or 80%, or 85%, or 90%, or 95%, or 99%, or 99.99%. The balance of the catalyst is oxygen, or one or more other surface moieties described herein, or one or more elements selected from the group consisting of oxygen, boron, nitrogen, sulfur, phosphorous, fluorine, chlorine, bromine and iodine. In some embodiments, a graphene oxide or graphite oxide has an oxygen content of at least about 0.01%, or 1%, or 5%, or 15%, or 20%, or 25%, or 30%, or 35%, or 40%, or 45%, or 50%. For example, a graphene or graphite oxide catalyst has a carbon content of at least about 25% and an oxygen content of at least about 0.01%. The oxygen content is measured with the aid of various surface or bulk analytical spectroscopic techniques. As one example, the oxygen content is measured by x-ray photoelectron spectroscopy (XPS) or mass spectrometry (e.g., inductively coupled plasma mass spectrometry, or “ICP-MS”).

In some embodiments, a carbocatalyst has a bulk carbon-to-oxygen ratio of at least about 0.1:1, or 0.5:1, or 1:1, or 1.5:1, or 2:1, or 2.5:1, or 3:1, or 3.5:1, or 4:1, or 4.5:1, or 5:1, or 5.5:1, or 6:1, or 6.5:1, or 7:1, or 7.5:1, or 8:1, or 8.5:1, or 9:1, or 9.5:1, or 10:1, or 100:1, or 1000:1, or 10,000:1, or 100,000:1, or 1,000,000:1. In some cases, a carbocatalyst has a surface carbon-to-oxygen ratio of at least about 0.1:1, or 0.5:1, or 1:1, or 1.5:1, or 2:1, or 2.5:1, or 3:1, or 3.5:1, or 4:1, or 4.5:1, or 5:1, or 5.5:1, or 6:1, or 6.5:1, or 7:1, or 7.5:1, or 8:1, or 8.5:1, or 9:1, or 9.5:1, or 10:1, or 100:1, or 1000:1, or 10,000:1, or 100,000:1, or 1,000,000:1.

In some embodiments, a catalytically-active graphene oxide or graphite oxide-containing catalyst has graphene oxide or graphite oxide with a bulk carbon-to-oxygen ratio of at least about 0.1:1, or 0.5:1, or 1:1, or 1.5:1, or 2:1, or 2.5:1, or 3:1, or 3.5:1, or 4:1, or 4.5:1, or 5:1, or 5.5:1, or 6:1, or 6.5:1, or 7:1, or 7.5:1, or 8:1, or 8.5:1, or 9:1, or 9.5:1, or 10:1, or 100:1, or 1000:1, or 10,000:1, or 100,000:1, or 1,000,000:1. In some cases, a graphene oxide or graphite oxide-containing catalyst includes graphene oxide or graphite oxide with a surface carbon-to-oxygen ratio of at least about 0.1:1, or 0.5:1, or 1:1, or 1.5:1, or 2:1, or 2.5:1, or 3:1, or 3.5:1, or 4:1, or 4.5:1, or 5:1, or 5.5:1, or 6:1, or 6.5:1, or 7:1, or 7.5:1, or 8:1, or 8.5:1, or 9:1, or 9.5:1, or 10:1, or 100:1, or 1000:1, or 10,000:1, or 100,000:1, or 1,000,000:1.

pH

In some cases, a heterogeneous catalytically active carbocatalyst (e.g., graphene oxide or graphite oxide catalyst, or other carbon and oxygen-containing catalyst) provides a solution pH of between about 0.1 to about 14 when dispersed in solution. In some cases, a heterogeneous catalytically active carbocatalyst (e.g., graphene oxide or graphite oxide catalyst, or other carbon and oxygen-containing catalyst) provides a reaction solution pH which is acidic (e.g., pH of between about 0.1 to about 6.9) when dispersed in solution. In some cases, a heterogeneous catalytically active carbocatalyst (e.g., graphene oxide or graphite oxide catalyst, or other carbon and oxygen-containing catalyst) provides a reaction solution pH which is basic (e.g., pH of between about 7.1 to about 14) when dispersed in solution. In some cases, a heterogeneous catalytically active carbocatalyst (e.g., graphene oxide or graphite oxide catalyst, or other carbon and oxygen-containing catalyst) provides a reaction solution pH which is neutral (e.g., pH of about 7) when dispersed in solution.

By way of example, in one embodiment, “acidic graphene oxide or graphite oxide” that provides a solution pH of 1-3 versus a solution pH of 4-6 is prepared by eliminating the certain optional steps in the material's preparation that involve washing with water. Normally, after the synthesis of a graphene oxide or graphite oxide catalyst is performed in acid, the graphene oxide or graphite oxide is washed with a large volume of water to remove this acid. When the number of wash steps is reduced, a graphene oxide or graphite oxide catalyst with a large amount of exogenous acid adsorbed to its surface is formed and the pH of the solution is lower compared to the pH when the catalyst is prepared by washing the material with water.

In another embodiment, graphene oxide or graphite oxide is basified by exposure to a base. Such a basic graphene oxide or graphite oxide catalyst is prepared by stirring a dispersion of graphene oxide or graphite oxide in water with non-nucleophilic bases such as potassium carbonate or sodium bicarbonate, and isolated the resulting product by filtration. Such carbocatalysts display significantly higher pH values when dispersed in water (pH=6-8).

Accordingly, depending on choice of substrates (e.g., whether a starting material is sensitive to acid or base) a suitable carbocatalyst is prepared that provides either an acidic or basic pH upon dispersion in solution.

Stoichiometry and Catalyst Loading

In some embodiments, for any catalytically active carbocatalyst (e.g., graphene or graphite oxide) mediated reaction described herein, e.g., oxidation, hydration, dehydrogenation/aromatization, polymerization, condensation or tandem oxidation-condensation reactions, the amount of graphene oxide or graphite oxide used is anywhere between 0.01 wt % and 1000 wt %. As used herein, wt % designates weight of the catalyst as compared to the weight of the reactant or reactants. In particular embodiments, the graphene oxide or graphite oxide catalyst may constitute at least 0.01 wt %, between 0.01 wt % and 5 wt %, between 5 wt % and 50 wt %, between 50 wt % and 200 wt %, between 200 wt % and 400 wt %, between 400 wt % and 1000 wt %, or up to 1000 wt %. The amount of catalyst used may vary depending on the type of reaction. For example reactions in which the catalyst acts on a C—H bond may work well at higher amounts of catalyst, such as up to 400 wt %. Other reactions, such a polymerization reactions, may work well at lower catalyst levels, such as as little as 0.01 wt %.

In some situations, the groups present at the surface of a catalytically activated carbocatalyst (e.g., a peroxide moiety covalently bound to graphene or graphite oxide) are modified to provide stoichiometric control of a reaction.

Reaction Time

In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the catalyst is contacted with reactants for a period of time between about 0.01 seconds, or 0.1 seconds, or 1 second, or 10 seconds, or 30 seconds, or 1 minute, or 5 minutes, or 10 minutes, or 15 minutes, or 20 minutes, or 30 minutes, or 1 hour, or 2 hours, or 3 hours, or 4 hours, or 5 hours, or 6 hours, or 12 hours, or 24 hours to about 1 minute, or 5 minutes, or 10 minutes, or 15 minutes, or minutes, or 30 minutes, or 1 hour, or 2 hours, or 3 hours, or 4 hours, or 5 hours, or 6 hours, or 12 hours, or 24 hours, 48 hours, 72 hours, 5 days, 1 week, or any suitable length of time.

In some embodiments, for any catalytically active carbocatalyst (e.g., graphene or graphite oxide) mediated reaction described herein, e.g., an additive polymerization, a condensation polymerization (e.g., a dehydrative polymerization), a ring opening polymerization, a cationic polymerization, an oxidative polymerization, a dehydrohalogenation polymerization, and the like, the duration of the reaction (e.g., for more than about 60%, about 70%, about 80%, about 90%, about 95% or about 100% conversion of starting material to product) is from seconds to minutes, from minutes to hours, or from hours to days. In one embodiment, for any catalytically active carbocatalyst mediated reaction described herein, the duration of the reaction is from about 1 second to about 5 minutes. In one embodiment, for any catalytically active carbocatalyst mediated reaction described herein, the duration of the reaction is from about 5 minutes to about 30 minutes. In one embodiment, for any catalytically active carbocatalyst mediated reaction described herein, the duration of the reaction is from about 30 minutes to about 60 minutes. In one embodiment, for any catalytically active carbocatalyst mediated reaction described herein, the duration of the reaction is from about 60 minutes to about 4 hours. In one embodiment, for any catalytically active carbocatalyst mediated reaction described herein, the duration of the reaction is from about 4 hours to about 8 hours. In one embodiment, for any catalytically active carbocatalyst mediated reaction described herein, the duration of the reaction is from about 8 hours to about 12 hours. In one embodiment, for any catalytically active carbocatalyst mediated reaction described herein, the duration of the reaction is from about 8 hours to about 24 hours. In one embodiment, for any catalytically active carbocatalyst mediated reaction described herein, the duration of the reaction is from about 24 hours to about 2 days. In one embodiment, for any catalytically active carbocatalyst mediated reaction described herein, the duration of the reaction is from about 1 day to about 3 days. In one embodiment, for any catalytically active carbocatalyst mediated reaction described herein, the duration of the reaction is from about 1 day to about 5 days. In one embodiment, for any catalytically active carbocatalyst mediated reaction described herein, the duration of the reaction is from about 1 day to about 6 days. Optionally, reaction time is modified (e.g., reduced) by microwave irradiation of a reaction mixture.

Reaction Temperature

In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about −78° C., −65° C., −50° C., −25° C., −15° C., −10° C., −5° C., 0° C., 5° C., 10° C., 15° C., 20° C., 25° C., 35° C., 50° C., 60° C., 80° C., and about 25° C., 50° C., 100° C., 150° C., 200° C., 250° C., 300° C., 500° C., 600° C., 700° C., 800° C., 900° C., or about 1000° C.

In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about −78° C. and about 1000° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about −78° C. and about 800° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about −50° C. and about 1000° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about −50° C. and about 800° C.

In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about −25° C. and about 1000° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about −25° C. and about 800° C.

In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 0° C. and about 500° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 0° C. and about 300° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 0° C. and about 100° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 25° C. and about 300° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 25° C. and about 200° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 25° C. and about 100° C.

In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 50° C. and about 300° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 50° C. and about 200° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 50° C. and about 150° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 50° C. and about 100° C.

In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 75° C. and about 300° C. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a temperature between about 75° C. and about 200° C.

Pressure

In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at atmospheric pressure. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a pressure of between about 1 atm to about 150 atm. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a pressure of between about 5 atm to about 150 atm. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a pressure of between about 10 atm to about 150 atm. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a pressure of between about 20 atm to about 150 atm. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a pressure of between about 50 atm to about 150 atm. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a pressure of between about 100 atm to about 150 atm. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a pressure of between about 1 atm to about 100 atm. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a pressure of between about 5 atm to about 50 atm. In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out at a pressure of between about 10 atm to about 50 atm.

Oxygenation

In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction is carried out under ambient atmosphere. In further embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), the reaction mixture is further oxygenated with an additional oxygen stream, thereby allowing for control of reaction products and/or reaction efficiency and/or conversion ratios. In other embodiments, the reaction mixture is further oxygenated with a sacrificial chemical oxidant such as ozone, hydrogen peroxide, oxone, potassium permanganate, organic peroxides, peroxy acids, perruthenates, lead tetraacetate, chromium oxides, periodates, potassium peroxymonosulfate, sulfur dioxide, chlorates, perchlorates, hypochlorites, perborates, nitrates, nitrous oxide, dinitrogen tetraoxide, silver oxide, osmium tetraoxide, 2,2′-dipyridyldisulfide, ammonium cerium nitrate, benzoquinone, Dess Martin periodinane, a Swern oxidation reagent, molybdenum oxides, pyridine N-oxide, vanadium oxides, TEMPO, potassium ferricyanide, or the like.

Solvent

In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), a suitable solvent is any solvent having low reactivity toward the carbocatalyst. In one embodiment, a chlorinated solvent is used, e.g., dichloromethane, chloroform, tetrachloromethane, dichloroethane and the like. In other situations, solvents such as acetonitrile or DMF are used. In some embodiments, water is used as a solvent. Less preferred solvents include solvents such as methanol, ethanol and/or tetrahydrofuran.

In further optional embodiments, the reaction is free of solvent. In another case, a reaction comprises a liquid reactant which is contacted with a catalytically active carbocatalyst as described herein, and the reaction is thereby free of additional solvent. In another case, a reaction comprises a solid reactant which is contacted with a catalytically active carbocatalyst as described herein, wherein upon heating, the solid melts to form a liquid reactant.

Gaseous Phase Reactions

In further embodiments, a reaction comprises a gaseous reactant (e.g., ethylene) which is contacted with a heated catalytically active carbocatalyst as described herein. In such instances, a gaseous phase reaction may occur under vacuum, ambient atmospheric pressure, or at elevated pressures (e.g., in a bomb reactor, or a high pressure reactor).

Reactor Systems

In some embodiments, any reaction described herein is a batch reaction. In other embodiments, any reaction described herein is a flow reaction.

Catalysts provided herein can be provided in systems having reactors and various separations unit operations (“units”) for effecting the separation of reactants and products.

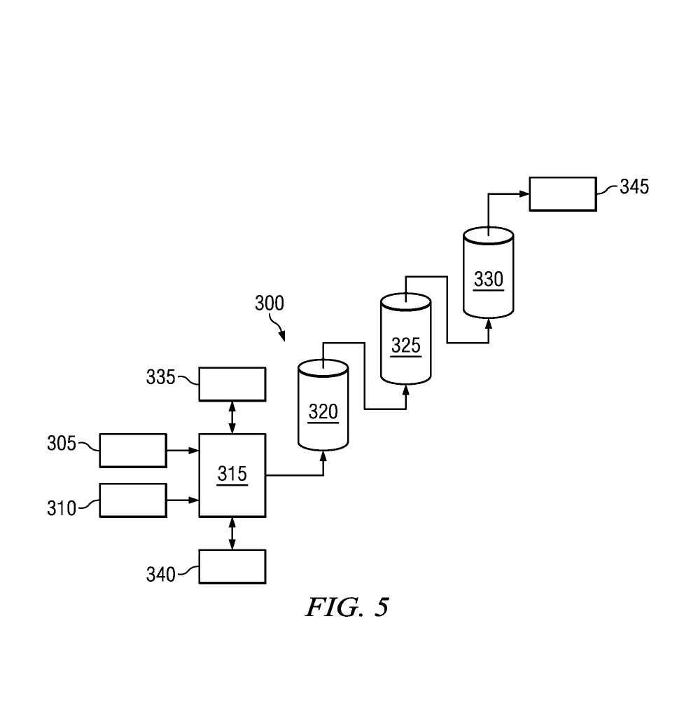

FIG. 5 shows a system 300 having reactant storage units 305 and 310, a reactor 315 downstream from the reactant storage units 305 and 310, and a plurality of separation units downstream from the reactor 315. The system 300 can be used with any of the reactions provided herein.

With continue reference to FIG. 5, the plurality of separation units includes a first distillation column 320, second distillation column 325 and third distillation column 330. Each of the distillation column includes one or more vapor-liquid equilibrium stages (or “trays”) for effecting a separation of a fluid. Additionally, each of the distillation columns includes a condenser and a reboiler (not shown). The plurality of separation units are configured to separate reaction products (formed in the reactor 315) from other products, byproducts and unused reactants. In some cases, one or more reactants separated by the plurality of separation unit operations is recycled to the reactor 315 to be reacted with the aid of the carbocatalyst in the reactor 315.

While the system 300 includes three distillation columns 320, 325 and 330, the system 300 can include fewer or more distillation columns, as required to effect the separation of a mixture of a predetermined composition. In an example, the system 300 includes only one distillation column. As another example, the system 300 includes 2, 4, 5, 6, 7, 8, 9, 10, 11, 12, 13, 14, 15, or more distillation columns. The number of distillation columns may be selected based on any unused reactants and the number of products generated in the reactor 315. For example, if the reactor generates propene and isopropanol, a single distillation column may be sufficient to effect the separation of propene and isopropanol into a propene stream (from the top of the distillation column) and an isopropanol stream (from the bottom of the distillation column). However, in cases in which a product stream from the reactor 315 includes unused reactant(s), then additional distillation columns may be required to separate the unused reactant(s) from the product(s).

The system 300 includes a heat exchanger 335 in thermal communication with the reactor 315 for providing heat to or removing heat from the reactor. In some situations, the heat exchanger 335 is in fluid communication with other devices, such as a pumps, for circulating a working fluid to and from the heat exchanger 335.

The system 300 includes a catalyst regenerator 340 in fluid communication with the reactor 315 configured to regenerate a carbocatalyst, such as a graphene oxide or graphite oxide-containing catalyst, from a spent catalyst. In some situations, the catalyst regenerator 340 is in fluid communication with a source of a oxidizing chemical for oxidizing a spent carbocatalyst.

The system 300 includes one or more product storage units (or vessels) for storing one or more reaction products. For example, the system 300 includes a storage unit 345 for storing a product from the third distillation column 330.

The system 300 may include other unit operations. In an example, the system includes one or more unit operations selected from filtration units, solid fluidization units, evaporation units, condensation units, mass transfer units (e.g., gas absorption, distillation, extraction, adsorption, or drying), gas liquefaction units, refrigeration units, and mechanical processing units (e.g., solids transport, crushing, pulverization, screening, or sieving).

The reactor 315 includes a carbocatalyst for facilitating a chemical reaction, such as an oxidation or polymerization reaction. In some embodiments, the carbocatalyst includes graphene, graphene oxide, graphite and/or graphite oxide. In some situations the carbocatalyst includes graphene oxide or graphite oxide.

In some cases, the reactor 315 is operated under vacuum. In some embodiments, the reactor 315 is operated at a pressure less than about 760 torr, or 1 ton, or 1×10⁻³ torr, or 1×10⁻⁴ torr, or 1×10⁻⁵ torr, or 1×10⁻⁶ torr, or 1×10⁻⁷ torr, or less. In other cases, the reactor 315 is operated at elevated pressures. In some embodiments, the reactor 315 is operated at a pressure of at least about 1 atm, or 2 atm, or 3 atm, or 4 atm, or 5 atm, or 6 atm, or 7 atm, or 8 atm, or 9 atm, or 10 atm, or atm, or 50 atm, or more.

In some embodiments, the reactor 315 is a plug flow reactor, continuous stirred tank reactor, semi-batch reactor or catalytic reactor. In some situations, a catalytic reactor is a shell-and-tube reactor or fluidized bed reactor. In other situations, the reactor 315 includes a plurality of reactors in parallel. This can aid in meeting processing needs while keeping the size of each of the reactors within predetermined limits. For example, if 500 liters/hour of ethanol is desired but a reactor is capable of providing 250 liters/hour, then two reactors in parallel will meet the desired output of ethanol.

In some situations, the reactor 315 is a shell-and-tube reactor having graphene oxide or graphite oxide on a solid support. In some situations, the solid support is a carbon-containing support, such as graphene, graphite, graphite oxide or graphene oxide, or a non-carbon containing support, such as an insulating, semiconducting or metallic support. In an example, the support includes one or more materials selected from AlOₓ, TiOₓ, SiOₓ and ZrOₓ, wherein ‘x’ is a number greater than zero.

In cases in which the reactor 315 is a shell-and-tube reactor, the reactor includes a housing having a reactor inlet and a reactor outlet downstream from the reactor inlet, and one or more tubes in fluid communication with the reactor inlet and the reactor outlet, the one or more tubes having one or more inner surfaces. In some situations, the one or more inner surfaces include graphene oxide, graphite oxide, or other carbocatalyst. In some cases, the one or more inner surfaces of the shell-and-tube reactor include graphene oxide or graphite oxide-containing particles. The one or more tubes are formed of a support material, such as, e.g., a carbon-containing support material (e.g., graphene, graphite, graphene oxide, or graphite oxide) or a non-carbon containing support material (e.g., metallic support material, insulating support material, semiconducting support material). In an example, the support material includes one or more materials selected from the group consisting of AlOₓ, TiOₓ, SiOₓ, and ZrOₓ, wherein ‘x’ is a number greater than zero.

In some embodiments, the shell-and-tube reactor includes a shell having 1 or more, or 2 or more, or 3 or more, or 4 or more, or 5 or more, or 6 or more, or 7 or more, or 8 or more, or 9 or more, or 10 or more, or 20 or more, or 30 or more, or 40 or more, or 50 or more, or 100 or more, or 200 or more, or 300 or more, or 400 or more or 500 or more, or 1000 or more tubes within the shell. In some situations, the tubes include the catalytically active material, such as a carbocatalyst (e.g., graphene oxide, graphite oxide). The shell-and-tube reactor can have a honeycomb configuration.

In some situations, the reactor 315 is a fluidized bed reactor. In an embodiment, the fluidized bed reactor includes graphene oxide, graphite oxide, or other carbon and oxygen-containing particles. In some cases, the fluidized bed reactor includes graphene oxide or graphite oxide-containing particles, such as particles having graphene oxide or graphite oxide coated on a solid support. In some cases, the solid support is a carbon-containing support. For instance, the particles include graphene oxide or graphite oxide on a support selected from the group consisting of graphene, graphite, graphite oxide and graphene oxide. In other cases, the particles include graphene oxide or graphite oxide on a non-carbon containing support, such as a metallic support, insulating support or semiconducting support. In an example, the support includes one or more materials selected from the group consisting of AlOx, TiOx, SiOx and ZrOx, wherein ‘x’ is a number greater than zero.

In cases in which the reactor 315 is a fluidized bed reactor, the reactor 315 includes a housing having a reactor inlet and a reactor outlet downstream from the reactor inlet and catalyst particles in the housing. In some situations, the catalyst particles include graphene oxide, graphite oxide, or other carbocatalyst. In some implementations, the reactor 315 includes a mesh at the reactor inlet and a mesh at the reactor outlet for preventing catalyst particles from leaving the reactor 315 during use of the reactor 315.

In some embodiments, the reactor 315 is a fluidized bed reactor and the particles, such as graphene oxide or graphite oxide-containing particles, have diameters between about 1 nanometer (“nm”) and 1000 micrometers (“□m”), or between about 10 nm and 500 □m, or between about 50 nm and 100 □m, or between about 100 nm and 10 □m.

The system 300 includes one or more pumps, valves and control system for regulating the flow of reactants to the reactor 315 and reaction products, byproducts and unused reactants from the reactor 315 and to and from various unit operations of the system 300. In an embodiment, a pump is selected from the group consisting of positive displacement pumps (e.g., reciprocating, rotary), impulse pumps, velocity pumps, gravity pumps, steam pumps, and valveless pumps. In another embodiment, pumps are selected from the group consisting of rotary lobe pumps, progressive cavity pumps, rotary gear pumps, piston pumps, diaphragm pumps, screw pumps, gear pumps, hydraulic pumps, vane pumps, regenerative (peripheral) pumps, peristaltic pumps. In other situations, such as for providing a vacuum to the reactor, the system 300 includes one or more pumps selected from the group consisting of mechanical pumps, turbomolecular (“turbo”) pumps, ion pumps, diffusion pumps and cryogenic (“cryo”) pumps that are in fluid communication with the reactor 315. In some cases, a pump is “backed” by one or more other pumps, such as a mechanical pumps. For example, a turbo pump is backed by a mechanical pump.

In some embodiments, valves are selected from the group consisting of ball valves, butterfly valves, ceramic disc valves, check valves (or non-return valves), hastelloy check valves, choke valves, diaphragm valves, stainless steel gate valves, globe valves, knife valves, needle valves, pinch valves, piston valves, plug valves, poppet valves, spool valves and thermal expansion valves.

Functional Groups

In some embodiments, for any catalytically active carbocatalyst mediated reaction described herein (e.g., an additive polymerization, a condensation polymerization (e.g., a dehydrative polymerization), a ring opening polymerization, a cationic polymerization, an oxidative polymerization, a dehydrohalogenation polymerization, and the like), a starting material comprises one or more functional groups. Within such substrates, in one embodiment, only one functional group is transformed (e.g., a substrate comprises an alkene and the polymer contains alcohol groups). In an alternate embodiment, more than one functional group is transformed (e.g., an alcohol group is oxidized and a alkene group is polymerized). In further embodiments, other functional groups present in an organic molecule are not affected by the reaction conditions described herein (i.e., the functional groups are stable to the reaction conditions). For example, a silyl ether is not cleaved under reaction conditions described herein while allowing for condensation polymerization.

In further embodiments, a functional group that is transformed is optionally allowed to undergo more than one transformation. For example, a methyl group is transformed to an alkene and further polymerized.

Turnover

In some embodiments, for any catalytically active carbocatalyst mediated reaction described herein, the turnover number for the reaction is on the order of 10⁻⁵ to about 1,000,000 or greater. In some embodiments, for any catalytically active carbocatalyst mediated reaction described herein, the turnover number for the reaction is on the order of 10⁻⁴ to about 10⁴. In an exemplary embodiment, for any catalytically active carbocatalyst mediated reaction described herein, the turnover number for the reaction is on the order of 10⁻² (expressed in moles of product per mass of catalyst).

Co-Catalyst

In some embodiments, for any catalytically active carbocatalyst mediated reaction described herein, the reaction mixture further comprises a co-catalyst. In one embodiment, such a co-catalyst is, for example, carbon nitride, boron nitride, boron carbon nitride, and the like. In some embodiments, a co-catalyst is an oxidation catalyst (e.g., titanium dioxide, Manganese dioxide). In some embodiments, a co-catalyst is a dehydrogenation catalyst (e.g., Pd/ZnO). In certain embodiments, a co-catalyst is a zeolite.

Co-Reagents

In further optional embodiments, any carbocatalyst mediated reaction described herein is optionally carried out in the presence of co-reagents. In one embodiment, such a co-reagent is an additional oxidizing reagent such as ozone, hydrogen peroxide, oxone, molecular oxygen, or the like. In another embodiment, an additional reagent may be a complementary reagent having synergy with the procedures described herein such as a Dess Martin periodinane reagent or a Swern oxidation reagent.

Co-Catalysts and Catalysts Supported on Graphite Oxide and Catalysts Operated in the Presence of Graphite Oxide or Other Carbocatalysts

Graphene oxide or graphite oxide and other carbocatalysts are active when used in conjunction with other catalytic molecules or materials. The additional catalysts are metal-containing, organic, inorganic, or macromolecular, and may operate via disparate or identical reaction mechanisms operative in graphene oxide- or graphite oxide-based catalysis. The catalysts are supported on graphene oxide or graphite oxide via chemisorption (e.g., through a ligation interaction with the chemical functionality present on graphene oxide or graphite oxide) or physisorption. The catalysts (either graphene oxide or graphite oxide or the added species) are enhanced through cooperative chemical effects between graphene oxide or graphite oxide and the catalysts, or may benefit from graphene oxide or graphite oxide's high surface area and available reactive sites. Metal-containing, organic, inorganic, or macromolecular catalysts are also employed in the presence of graphene oxide or graphite oxide, where the two have no interaction and the graphene oxide or graphite oxide operates solely as a spectator species. The catalyst retains its inherent reactivity and is unaffected by the presence of the graphene oxide or graphite oxide.

Graphite Intercalation Compounds as Catalysts

Graphene oxide or graphite oxide and other carbocatalysts are active in the formation of intercalation compounds (ICs). When formed from graphite-based materials, these materials are known as graphite intercalation compounds (GICs). ICs and GICs are formed through the insertion of a small molecule or polymer into the interlayer region of the stacked structure of graphite and other similar carbon materials. The intercalants are metallic (e.g., metal salts, coordination complexes), organic (e.g., aryl or aliphatic species), inorganic (e.g., mineral acids), or macromolecules and exhibit diverse chemical properties such as ionic character, various functional groups, and various physical states (i.e., gas, liquid, solid). These ICs and GICs are reactive, either catalytically or stoichiometrically, and are considered non-covalently functionalized carbocatalysts. The reactivity of the GIC is a result of the carbon material itself or the intercalant, or the combination thereof. Though the carbon material or intercalant enhances the inherent reactivity of the other, either the carbon material of the intercalant may also be an inert spectator species.

### Carbocatalyst Catalyzed Transformations

Graphene oxide or graphite oxide is used in a variety of reactions, and is used for activation of unactivated substrates (e.g., hydrocarbon monomers) and/or oxidation or hydrations or dehydrations of other reactive substrates (e.g., alkenes, alkynes or other substrates described herein), and/or for condensation or dehydrogenation reactions of a variety of inert or activated substrates. In these reactions, graphene oxide or graphite oxide exerts its catalytic effect through one or more of exemplary properties such as acidic properties, dehydrative properties, oxidative properties, dehydrogenation properties, dehydrohalongenation properties, redox properties, or any combination thereof.

### Polymerization

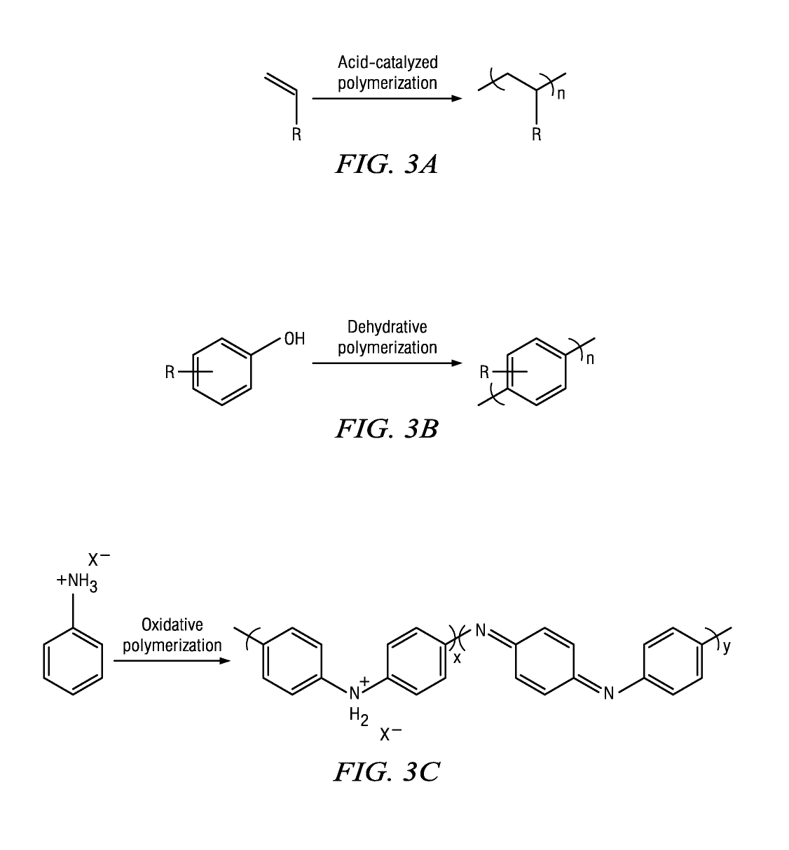

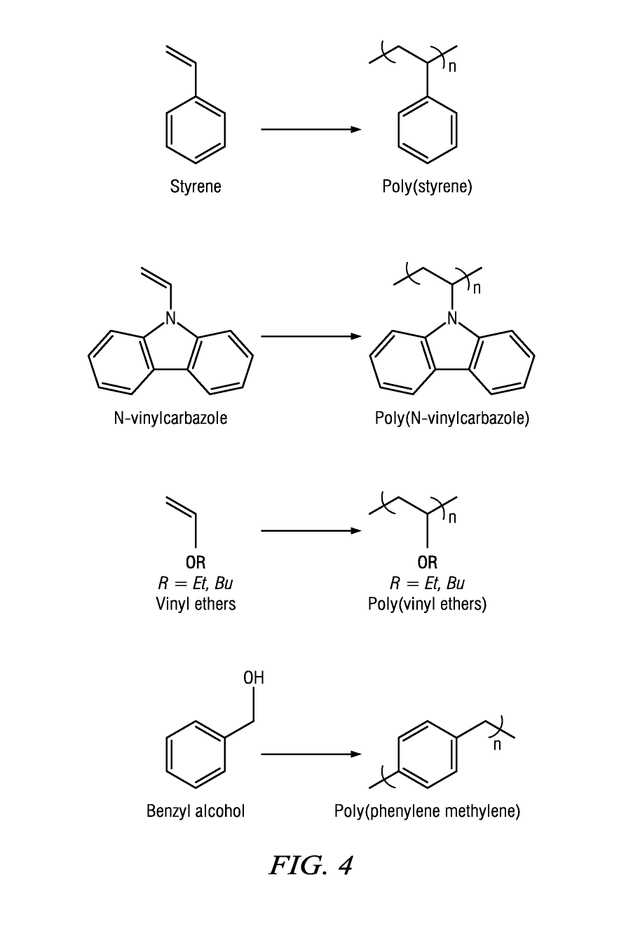

As shown in FIGS. 3 and 4, graphene oxide or graphite oxide is suitable for catalyzing a polymerization of a variety of monomers. In particular, graphene oxide or graphite oxide may catalyze oxidative, dehydrative, or cationic polymerization. Polymers that are formed using these methods include poly(styrene), which is formed though cationic polymerization, poly (alkyl vinyl ether), such as poly(ethyl vinyl ether), which is formed though cationic polymerization, poly(N-vinyl carbazole), which is formed though cationic polymerization, poly(phenylene methylene), which is formed though dehydrative polymerization, poly(4-methoxybenzyl alcohol), which is formed though dehydrative polymerization, poly(furfuryl alcohol), which is formed though dehydrative polymerization, poly(2-thiophenemethanol), which is formed though dehydrative polymerization, poly(1-phenylethanol), which is formed though dehydrative polymerization, poly(2-phenyl-2-propanol), which is formed though dehydrative polymerization, and poly(aniline), which is formed though oxidative polymerization. Mixed polymers, such as combinations of the polymers recited above, are formed by using mixtures of monomers. The methods described herein are also suitable for synthesis of copolymers of more than one monomer type, such as block copolymers (e.g. polymers of the general structure AAAAAA-BBBBBB). In still other embodiments, polymers formed from more than one monomer type polymerized through different polymerization reactions catalyzed by the graphene oxide or graphite oxide are formed (e.g. one monomer may be polymerized through oxidation polymerization and the other through dehydrative polymerization).

Oxidative Polymerization

GO and other carbocatalysts described herein have been found to catalyze oxidative reactions of compounds such as phenol, aniline, diphenyl disulfide, benzene, pyrrole, thiophene, their derivatives, and the like,—a property that is employed in, e.g., oxidative polymerization. Some polymers synthesized by this method, include and are not limited to poly(phenylene oxide)s, polyphenols, polyanilines, poly(phenylene sulfide)s, polyphenylenes, polypyrroles, and polythiophenes, and the like.

Cationic Polymerization

GO and other carbocatalysts described herein have been found to catalyze Lewis acid or protic acid catalyzed reactions of substrates, such as olefins with electron-donating substituents and heterocycles,—a property that is employed in, e.g., cationic polymerization. Some polymers synthesized by this method, include and are not limited to polyisobutylene, poly(N-vinylcarbazole), and the like.

Ring Opening Polymerization

GO and other carbocatalysts described herein have been found to catalyze ring opening reactions of substrates, such as lactams, silanes, expoxides and the like,—a property that is employed in, e.g., ring opening polymerizations. Some polymers synthesized by this method, include and are not limited to polyamides, polysiloxanes, epoxies, and the like.

Additive Polymerization

GO and other carbocatalysts described herein have been found to catalyze reactions of substrates, such as olefins, nitriles, isocyanates and the like,—a property that is employed in, e.g., additive polymerizations. Some polymers synthesized by this method, include and are not limited to polyolefins, polyurethanes, polyesters, and the like.

Dehydrative Polymerization

GO and other carbocatalysts described herein have been found to catalyze the dehydration of primary and secondary alcohols—a property that is employed in, e.g., condensation polymerization. The alcohols comprise linear, cyclic, or branched alkanes; aryl or heterocycle substitutents; heteroatoms; or polymers. The products of these reactions are alkenes, as in the formation of ethylene from ethanol or styrene from phenylethanol or acrolein from glycerol. The products of these reactions are ethers, as in the formation of diethylether from ethanol or tetrahydrofuran from 1,4-butanediol. The products of these reactions are acid anhydrides, as in the formation of acetic anhydride from acetic acid or succinic anhydride from succinic acid. The products of these reactions are nitriles, as in the formation of benzonitrile from benzamide or acetonitrile from acetamide.

For any of the reactions described above and below, the polymerizations are performed over broad pH ranges as described herein. Combinations of products are possible and are separated accordingly, or are reacted in situ to form more complex molecules. In the case of the preparation of reactive monomers from appropriate precursors (e.g., styrene from phenylethanol or acrolein from glycerol), these monomers polymerize in the presence of GO, resulting in the formation of a polymer composite. In some cases, cross linked polymers are formed.

Copolymers are also possible when these precursors are combined either in parallel or in series. Dehydrating and/or other agents (e.g., dehydrohalogenation agents) or monomers (catalytic or stoichiometric) other than GO are optionally employed in addition to GO. In some cases, these agents have synergistic effects with GO, and in some cases the GO will be an inert spectator. The polymerization reaction is performed with solvent or in the absence of solvent. A wide range of GO loadings is used as described herein, for example between about 0.01 to about 1000 wt %. The reaction is performed over a wide range of temperatures as described herein, e.g., between about −78° C. to about 350° C.

Dehydrations with Graphite Oxide/Zeolite Catalyst Mixtures

Also contemplated within the scope of the embodiments herein are dehydration polymerizations that are catalyzed with a mixture of graphite oxide and a zeolite. It has been found that the catalytic activity of GO in dehydration reactions is improved with the use of a zeolite catalyst as a co-catalyst. The zeolite catalyst is selected from, but is not limited to, faujasite (FAU), zelolite socony mobil-5 (ZSM-5), mordenite (MOR), or ferrierite (FER). The zeolite catalyst may be dissolved and blended with GO in solution or in the solid state. A wide range of zeolite loadings is used, e.g., between about 0.01 to about 1000 wt %. The reaction conditions for dehydration reactions catalyzed with a GO/zeolite catalyst mixture are similar to the reaction conditions used for the GO-catalyzed dehydration reactions. The dehydration reaction with the GO/zeolite catalyst mixture is performed over a wide range of temperatures, e.g., between about room temperature to about 350° C. The dehydration polymerization is performed with solvent or in the absence of solvents.

For any reactions described above and below, to facilitate removal of the graphene oxide or graphite oxide material, it is optionally not covalently bound to the polymer matrix. In other instances, the graphene oxide or graphite oxide material remains dispersed within the polymer matrix.

Accordingly contemplated within the scope of embodiments presented herein is the use of carbocatalysts described herein and methods described herein for synthesis of polymers including and not limited to the following classes of polymers:

Polyesters:

GO has been found to be active in the formation of polyesters. These reactions are, in one instance, in the form of ring opening reaction of cyclic esters, such as in the case of ε-caprolactone to poly(caprolactone). In another instance, these reactions are in the form of acid-catalyzed AB or A₂+B₂ reactions, such as in the case of reacting terephthalic acid with ethylene glycol to form poly(terephthalate). Both aromatic and aliphatic acids and esters will show reactivity, and in addition to those mentioned above, the following polymers are also contemplated as viable targets using this method: poly(glycolide), poly(lactic acid), poly(ethylene adipate), poly(hydroxyalkanoate), poly(butylene terephthalate), poly(trimethylene terephthalate), poly(ethylene naphthalate), Vectran, and the like. Block copolymers of these polymers with other polymers (e.g., polyamides, for forming polyesteramides) are contemplated as well.

In one embodiment provided herein is a method for synthesis of a polyester (e.g., any polyester described herein) or a co-polymer, composite, or co-polymer-composite thereof, comprising contacting monomers with a catalytically active carbocatalyst; and transforming the monomers with the aid of the catalytically active carbocatalyst to form a mixture of a polymer product and a spent or partially spent carbocatalyst.

Polyamides:

GO is active in the formation of polyamides. These reactions are, in one instance, in the form of ring opening reaction of cyclic amides, such as in the case of ε-caprolactam to poly(caprolactam) (i.e., nylon 6). In another instance, these reactions are in the form of acid-catalyzed AB or A₂+B₂ reactions, such as in the case of reacting adipic acid with hexamethylene diamine to form nylon 6,6. Both aromatic and aliphatic acids and amines show reactivity, and in addition to those mentioned above, the following polymers are contemplated as viable targets using this method: polyphthalimides and aramides (e.g., Kevlar and Nomex). Block copolymers of these polymers with other polymers (e.g., polyesters, for forming polyesteramides) are contemplated as well.

In one embodiment provided herein is a method for synthesis of a polyamide (e.g., any polyamide described herein) or a co-polymer, composite, or co-polymer-composite thereof, comprising contacting monomers with a catalytically active carbocatalyst; and transforming the monomers with the aid of the catalytically active carbocatalyst to form a mixture of a polymer product and a spent or partially spent carbocatalyst.

Polyolefins:

GO has been found to be active in the formation of polyolefins. Both aromatic and aliphatic monomers show reactivity, and the following polymers are suitable for synthesis using this method: poly(styrene), poly(N-vinyl carbazole), poly(vinyl ether)s, poly(isobutylene), poly(vinylchloride), poly(propylene), poly(ethylene), poly(isoprene), poly(butadiene). The polymers are atactic, isotactic, or syndiotactic, and the atactic polymers are enhanced sufficiently by the incorporation of GO to allow displacement in applications where isotactic or syndiotactic polymers are currently required. Block copolymers of these polymers with other olefin-derived polymers are formed as well.

In one embodiment provided herein is a method for synthesis of a polyolefin (e.g., any polyolefin described herein) or a co-polymer, composite, or co-polymer-composite thereof, comprising contacting monomers with a catalytically active carbocatalyst; and transforming the monomers with the aid of the catalytically active carbocatalyst to form a mixture of a polymer product and a spent or partially spent carbocatalyst.

Polyurethanes:

GO is active in the formation of polyurethanes. A wide range of mono- or polyfunctional isocyanates, alcohols, or amines are reacted with each another for this purpose. Both aromatic and aliphatic species show good reactivity. The most common and commercially relevant isocyanates that are polymerized are toluene diisocyanate and methylene diisocyanate. The most common and commercially relevant alcohols that are polymerized are ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, glycerol, trimethylolpropane, 1,2,6-hexanetriol, and pentaerythritol. The most common and commercially relevant amines that are polymerized are ethanolamine, diethanolamine, methyldiethanolamine, phenyldiethanolamine, triethanolamine, N,N,N′,N′-tetrakis(2-hydroxypropyl)ethylenediamine, diethyltoluenediamine, and dimethylthiotoluenediamine.

In one embodiment provided herein is a method for synthesis of a polyurethane (e.g., any polyurethane described herein) or a co-polymer, composite, or co-polymer-composite thereof, comprising contacting monomers with a catalytically active carbocatalyst; and transforming the monomers with the aid of the catalytically active carbocatalyst to form a mixture of a polymer product and a spent or partially spent carbocatalyst.

Polysiloxanes:

GO is active in the formation of polysiloxanes (also known as silicones). These reactions are in the form of dehydrohalogenation reactions, such as in the reaction of dimethyldichlorosilane to form polydimethylsiloxane (PDMS). These reactions are optionally in the form of ring opening reactions, such as in the reaction of decamethylcyclopentasiloxane to form PDMS. While PDMS is the most commercially important polysiloxane, a wide range of aliphatically and aromatically substituted silanes and siloxanes are reactive.

In one embodiment provided herein is a method for synthesis of a polysiloxane (e.g., any polysiloane described herein) or a co-polymer, composite, or co-polymer-composite thereof, comprising contacting monomers with a catalytically active carbocatalyst; and transforming the monomers with the aid of the catalytically active carbocatalyst to form a mixture of a polymer product and a spent or partially spent carbocatalyst.

Epoxies:

GO is active in the formation of epoxy resins. These reactions are in the form of a ring opening of an epoxide-containing monomer, such as glycidyl alcohol or oxirane. These reactions are optionally in the form of a two-part epoxy mixture where an epoxide-containing monomer (the “resin”) is reacted with GO and a separate polyol or polyamine (the “hardener”), such as triethylenetetramine. A wide range of epoxide-containing monomers are used, in addition to those above, including propylene oxide, styrene oxide, (2,3-epoxypropyl)benzene, 1,2,7,8-diepoxyoctane, 1,2-epoxy-2-methylpropane, 1,2-epoxy-3-phenoxypropane, 1,2-epoxybutane, 1,2-epoxypentane, 2-methyl-2-vinyloxirane, 3,4-epoxy-1-butene, cyclohexene oxide, and cyclopentene oxide. A wide range of polyols or polyamines may also be used, including triethylenetetramine, ethylene glycol (and oligomers thereof), propylene glycol, triethanolamine, ethylenediamine, tris(2-aminoethyl)amine, putrescine, cadaverine, spermidine, spermine, xylylenediamine, or polymeric species such as poly(vinyl alcohol) or poly(allyl amine).

In one embodiment provided herein is a method for synthesis of an epoxy (e.g., any epoxy described herein) or a co-polymer, composite, or co-polymer-composite thereof, comprising contacting monomers with a catalytically active carbocatalyst; and transforming the monomers with the aid of the catalytically active carbocatalyst to form a mixture of a polymer product and a spent or partially spent carbocatalyst.

Polycarbonates:

GO and other carbocatalysts are active in the formation of polycarbonates and composites thereof. These polymeric/composite materials are formed from A2+B2-type polymerizations, as in the reaction of alcohols (e.g., bisphenol A, 1,1-bis(4-hydroxyphenyl)cyclohexane, dihydroxybenzophenone, and tetramethylcyclobutanediol) with electrophilic ketones (e.g., phosgene, formic acid, etc.). Either the alcohol or the ketone component (or both) of the reaction is optionally multifunctional. Examples of multifunctional alcohols (more than 2 alcohol moieties on a single molecule) include glycerol, triethanolamine, pentaerythritol, and various polyols. Examples of multifunctional ketones include ethylene glycol diformate, 1,4-butanediol diformate, and other multifunctional formates. Polycarbonates are also formed through carbonate-ester interchange, as in the polymerization of allyl diglycol carbonate (also known as CR-39) or bisphenol-A diacetate with dimethyl carbonate. Polycarbonates are also formed using ring opening methods applied to cyclic carbonates, as in the ring opening polymerization of 5-methyl-5-benzyloxycarbonyl-1,3-dioxan-2-one, 2,2-dimethyltrimethylene carbonate, 2-phenyl-5,5-bis(hydroxymethyl)trimethylene carbonate, or 5,5-dimethyl trimethylene carbonate to their corresponding macromolecules. The GO catalyzes these polymerizations through acidic or other mechanisms, or may be an inert spectator species.

In one embodiment provided herein is a method for synthesis of a polycarbonate (e.g., any polycarbonate described herein) or a co-polymer, composite, or co-polymer-composite thereof, comprising contacting monomers with a catalytically active carbocatalyst; and transforming the monomers with the aid of the catalytically active carbocatalyst to form a mixture of a polymer product and a spent or partially spent carbocatalyst.

### Latent Cross-Linking Using Functionalized Monomers

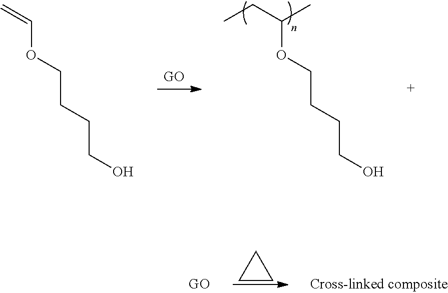

GO has been found to react in two distinct ways with olefinic monomers bearing nucleophilic (e.g., alcohols and amines) or electrophilic (e.g., carboxylate, ketones, and epoxides) groups as pendant functionality. First, the monomer can react with GO via a cationic polymerization pathway, as described previously, resulting in the polyolefin product. Following this formation of the polymer, the pendant functionality is condensed with the surface of GO (which bears both nucleophilic and electrophilic functionality of its own), resulting in a highly cross-linked composite. The polymerization reaction is conducted at a sufficiently low temperature (for example, below 100° C.) so as to avoid premature condensation of the functional groups with GO. In the case of 1,4-butanediol monovinyl ether, the polymer product formed after the acid-initiated polymerization exhibits fluid properties at room temperature. The GO is found to form a metastable suspension in the polymer. This pre-cross-linked suspension is poured into a mold or vessel and then annealed at a high temperature (above 100° C.) to initiate the cross-linking process. Upon cross-linking, the product no longer flows. This same reaction methodology is performed using other hydroxylated vinyl ethers, such as diethylene glycol monovinyl ether or triethylene glycol monovinyl ether. It is also performed using other hydroxylated monomers that can be polymerized cationically, including: 4-hydroxylstyrene or hydroxylated N-vinycarbazoles. Other nucleophiles, such as alkoxides, amines, nitrates, thiols, or thiolates, are installed in place of the hydroxyl groups on the monomers as well. Other electrophiles, such as carboxylates, alkenes, alkynes, alkyl halides, alkyl mesylates, alkyl tosylates, ketones, quinones, or diazonium salts are used as well.

### Graphite Fluoride

Graphite fluoride (GF) catalyzes a wide range of fluorination reactions. GF, also known as carbon monofluoride or poly(carbonfluoride), is prepared by reacting graphite or other carbon sources with a fluorine-containing molecule, such as fluorine gas. These reactions are performed with solvent or in the absence of solvent under a wide range of reaction conditions including, but not limited to, ambient or inert atmospheres; temperatures ranging from about −78° C. to about 350° C.; and catalyst loadings between about 0.01 to 1000 wt %, as described herein. The reactions are catalytic in GF, wherein the GF mediates the transfer of fluorine from a terminal source, such as fluorine gas or hydrofluoric acid, to the substrate. In other cases, the reactions are stoichiometric in GF, wherein the fluorine is transferred directly from the GF surface to the substrate. The fluorinations comprise the insertion of fluorine into the C—H bonds present in a variety of organic compounds, such as aryl or aliphatic compounds; cleavage of C—C or C—H bonds; halogen substitution reactions (e.g., substitution of chlorine, bromine, or iodine with fluorine); addition of fluorine to an unsaturated moiety, such as an alkene or alkyne; or some combination thereof. The reactive substrates are small molecules or polymers. The fluorinations comprise perfluorinations (i.e., the introduction of fluorine into all available C—H positions) or selective fluorinations (i.e., the introduction of fluorine to one or more specific locations). The fluorinations are enhanced through the use of an applied potential (e.g., electrofluorinations).

Contemplated within the scope of embodiments presented herein are chemical precursors of GF, such as fluorine-graphite intercalation compounds, and other carbon fluoride species that also catalyze fluorination reactions. GF, precursors of GF, or other carbon fluoride species are used independently, in the presence of, or in conjunction with other species including, but not limited to, other fluorination catalysts, such as metal, organic or polymeric fluorination catalysts; co-catalysts; or catalyst supports such as zeolites, silica, or alumina.

Fluorinated Polymers:

GF, precursors of GF, or other carbon fluoride species catalyze the addition of CₓF_{y} groups to aliphatic or aromatic compounds, wherein x and y are integers. These reactions are either catalytic in GF, precursors of GF, or other carbon fluoride species, wherein the CₓF_{y} moiety is used to mediate the transfer of CₓF_{y} from another source, such as F₃CSiMe₃ or CF₃OF, or the reactions are stoichiometric in GF, precursors of GF, or other carbon fluoride species. In the reactions that employ a stoichiometric amount of GF, precursors of GF, or other carbon fluoride species, the catalyst decompose thermally, chemically, electrochemically, or mechanically, yielding reactive carbon-fluorine fragments that react with organic, inorganic, or polymeric species. Contemplated within the scope of embodiments presented herein are GF-mediated perfluorinations of ethylene (e.g., synthesis of tetrafluoroethylene) and/or further polymerizations for synthesis of fluorinated polymers (e.g., Teflon®). Contemplated within the scope of embodiments presented herein are other hydrocarbon-based or heteroatomically-functionalized polymers, such as polybutadiene, polystyrene, polyesters, polyamides, and their derivatives that are converted to their corresponding fluorinated derivatives.

In one embodiment provided herein is a method for synthesis of a polyfluorinated polymer (e.g., any polyfluorinated polymer described herein) or a co-polymer, composite, or co-polymer-composite thereof, comprising contacting monomers with a catalytically active carbocatalyst; and transforming the monomers with the aid of the catalytically active carbocatalyst to form a mixture of a polymer product and a spent or partially spent carbocatalyst.

### Polymer Composites

Also contemplated within the scope of embodiments presented herein are polymer composites comprising any of the aforementioned polymers and graphene oxide or graphite oxide, or a derivative thereof. In a specific embodiment, graphene oxide or graphite oxide is used to form a polymer composite containing the graphene oxide or graphite oxide (or a derivative thereon) in the polymer matrix after formation. To form such a composite, the reaction is catalyzed using the graphene oxide or graphite oxide, which, after polymerization, is dispersed throughout the polymer matrix. To form a hollow polymer matrix, the graphene oxide or graphite oxide is removed. To form different composites, other materials are optionally added to the polymer matrix after the graphene oxide or graphite oxide is removed. To facilitate removal of the graphene oxide or graphite oxide material, it is optionally not covalently bound to the polymer matrix.

Although one advantage of the current reaction is ability to produce a carbon-filled polymer composite in a one-step process without the need to add a filler, carbon or other fillers are nevertheless added to the reaction mixture if needed, for example, to obtain a higher amount of filler or to provide a different type of filler.

Polymer composites synthesized by the methods described herein, particularly those containing carbon, are mechanically robust. Additionally, some, such as poly(aniline), are useful in energy storage.

In some embodiments, methods of the current disclosure catalyze even difficult polymerization reactions. For example, graphene oxide is used to polymerize benzyl alcohol to poly(phenylene methylene) as shown in FIG. 4. Typically, concentrated acids and high temperatures are required in order to promote dehydration polymerization of benzyl alcohol. Graphene oxide or graphite oxide is sufficiently acidic to promote the reaction at a high conversion rate at much lower temperatures than typically used with acid. Additionally, graphene oxide or graphite oxide are much safer than most acids typically used for this reaction. Such a polymerization reaction results in a polymer composite containing the graphene oxide or graphite oxide that is also mechanically and thermally robust.

In one aspect provided herein is a polymer composite comprising a spent or partially spent carbocatalyst having a particle size of between about 1 nm to about 1 nm dispersed in a polymer matrix. In some embodiments, the polymer is synthesized by contacting monomers with a catalytically active carbocatalyst having a particle size of between about 1 nm to about 1 micrometer for a time and at a temperature sufficient to allow catalysis of a polymerization reaction of the monomer to produce a polymer matrix. In another aspect, provided herein is a polymer composite comprising a metastable graphene dispersed in a polymer matrix. In yet another aspect, provided herein is a compounded polymer composite, wherein a first polymer composite described above is further compounded by contacting the polymer composite described above with additional monomers, or a pre-formed polymer, or an additional polymer composite to provide a compounded polymer composite.

Control of Particle Size

Polymer composites containing or prepared using GO or other carbon additives incorporate these carbon additives into their macroscopic structure. The size of these additive particles or lamellae can have a impact on the properties of the resulting composite. Mechanical, thermal, optical, barrier and electrical properties are influenced by the physical and chemical properties of the carbon additive in the composite. For example, carbon additives that are very small (smaller than the wavelength of light being passed through the composite) may be optically transparent. The use of additives and matrices that possess similar refractive indices may also be used to render a composite transparent. As another example, large, lamellar carbon additives that can connect to one another within the matrix may be used to induce electron or heat percolation within a composite at exceptionally low additive loadings, rendering the composite electrically and/or thermally conductive. Large, lamellar additives may also render composites less permeable to the diffusion of gases or other molecular entities.

The particle size and morphology of the carbocatalyst are optionally controlled by modifying one or more of the following: the starting materials (e.g., graphite source); reaction procedures used to prepare GO or other carbocatalysts (e.g., oxidant identity/content, reaction time, temperature, stirring protocols, etc.); and post-reaction procedures (e.g., filtration, centrifugation, ball milling, thermal treatment, etc.). Likewise, the polymerization procedures used to react the carbocatalyst with the monomer (e.g., time, temperature, mixing protocols, annealing, etc.) are optionally used to further control the particle size, as well as the extent and nature of the carbon additive's dispersion within the polymer matrix. In some embodiments, the particle size is between about 1 nm to about 1 μm. In some embodiments, the particle size is less than about 400 nm. In some embodiments, the particle size is between about 1 nm to about 400 nm. In some embodiments, the particle size is between about 1 nm to about 300 nm. In some embodiments, the particle size is between about 1 nm to about 200 nm. In some embodiments, the particle size is between about 1 nm to about 100 nm. In some embodiments, the particle size is between about 1 nm to about 50 nm.

Composite Compounding

Polymer composites containing GO or other carbon additives are used as sources of metastable graphene or other carbon additives. In some embodiments, metastable graphene refers to graphene that can be kinetically trapped within a polymer matrix. A material containing these additives as a composite (composite A, in the scheme shown below) is optionally blended with unreacted monomer, a separate pre-formed polymer or a separate composite (which may contain any additive, carbon or otherwise). The carbon additive initially dispersed in composite A then becomes dispersed in the product, forming a new composite entity (composite B, in the scheme shown below). The process effectively dilutes the carbon additive initially present in composite A, and composite B has entirely unique or coincidentally similar properties (mechanical, thermal, barrier, optical, electrical, etc.) as composite A does. Any method of blending composite A with the monomer, pre-formed polymer or composite is optionally utilized.

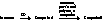

Polymer composites prepared by methods of the current disclosure are expected to have a variety of novel characteristics and improved features. In one aspect, polymer composites prepared by methods of the current disclosure are expected to have improved mechanical properties. In one aspect, polymer composites prepared by methods of the current disclosure are expected to have improved thermal properties. In one aspect, polymer composites prepared by methods of the current disclosure are expected to have improved electronic properties.

Methods of the current disclosure are used in a wide variety of applications. For example, the methods are used to produce low-cost or mechanically robust materials for use in the automotive and aerospace industries. Conductive composites are used in the electronics industry. The ability to use small amounts of carbon in polymer composites allows the production of low-weight materials, also useful in the automotive and aerospace industries. Simplicity of reactions, such as those that do not require additional reagents or solvents, facilitates their scale-up for industrial production.

Methods of the current disclosure also have applications in the pharmaceutical industry. Chalcones are important precursors for flavonoids and other pharmaceutically important materials and have many uses outside of the pharmaceutical industry. Additionally, the lack of metal in graphene oxide or graphite oxide allows the use of these methods in reactions where metal contamination is a concern, such as reactions to produce pharmaceuticals or agricultural products, or in reactions where it would be detrimental, such as where the product will be subjected to further reactions or used in further applications that are sensitive to metal contamination.

### Biofuels

GO and other carbocatalysts are active in the preparation and purification of biofuels, including algae-derived biodiesel. The reactions are performed by reacting GO directly with natural lipids or fatty acids (a wide range of precursors may be used in this role, ranging from crude biomass to highly purified lipids), and these reactions include transesterification reactions with water or alcohols to transform glycerides and other lipids into fatty acids or esters, biobutanol, biogasoline, or other biofuel products. GO is also used to purify biofuel streams prepared using other catalysts; this purification is performed in parallel or in series with respect to the aforementioned conversion of raw biomass to usable biofuels, representing single- and multi-step procedures, respectively. The activity of GO is expected to be retained in the presence of a wide range of naturally occurring contaminants found in crude biofuels. These contaminants include halogens (fluorine, chlorine, bromine, iodine) or halogen-containing molecules, metals, natural or synthetic organic and inorganic materials, or other biomass. When GO is used in conjunction with other catalysts, the GO reacts independently of the catalysts or exhibit synergistic effects.

In one embodiment provided herein is a method for synthesis of a biofuel (e.g., any biofuel described herein) comprising contacting precursors (e.g., precursors described herein) with a catalytically active carbocatalyst; and transforming the precursors with the aid of the catalytically active carbocatalyst to form a mixture of a biofuel and a spent or partially spent carbocatalyst.

### Degradable Polymers

GO and other carbocatalysts are used for formation of biodegradable polymer composites. When incorporated into a polymer, either through use as a polymerization catalyst or through blending with a polymer after the macromolecule's formation or through solution phase reactivity with a dissolved polymer, GO retains reactivity that is utilized. This reactivity is in the form of, for example, oxidation reactivity which allows for oxidation of polystyrene through the installation of oxygen functional groups (e.g., alcohols, ketones, ethers, esters, etc.). These functional groups are present either on or within the main chain of the polymer, as in the formation of carbonyl groups on the backbone of polystyrene (see scheme above) or the insertion of ether or ester moieties into the backbone. The inserted functional groups are also present, in some cases, as modifications of the pendant functionality inherently present in the polymer, as in the modification of the phenyl groups present in polystyrene (lower route on the above scheme). Upon introduction of functional groups, otherwise inert polymers, such as polystyrene, polyethylene, poly(methyl methacrylate) poly(methyl acrylate) and other inert polymers prepared using various methods, will be oxidized and thereby rendered reactive toward degradation by biological or non-biological sources. These degradation sources may be biological in nature, as in the use of bacteria, enzymes, or other biomass to depolymerize the material. These degradation sources may also be non-biological in nature, such as the use of steam treatment to depolymerize the material.

Graphene oxide or graphite oxide and other carbocatalysts is also used in acid- or base-catalyzed degradations of polymers. For example, polyesters and polyamides are reacted with the catalyst. In this mode of reactivity, the functional groups that form the backbone of the polymer are cleaved by reaction with functional groups present on the catalyst. The polymers susceptible to reaction through this pathway are, for example, aliphatic, such as poly(ε-caprolactone), aromatic, such as Kevlar or Nomex, or a mixture, such as poly(ethylene terephthalate). The polymers also encompass pure polyesters, pure polyamides, or a mixture of the two. The functionality susceptible to cleavage by the catalyst may also be part of the polymer's side chain(s), rather than exclusively a part of the polymer's backbone. In such a reaction scenario, the backbone of the polymer is left intact, while the side chains undergo transformation to their corresponding degradation products. For example, poly(vinyl acetate) is converted to poly(vinyl alcohol) through reaction of the former with graphene oxide or graphite oxide or other carbocatalysts. Similarly, poly(acrylic esters) such as poly(t-butyl acrylate) and poly(methyl acrylate) is reacted with graphene oxide or graphite oxide to form poly(acrylic acid). The degree of cleavage is controlled, affording various copolymers comprising the starting monomer and the cleaved monomer. The carbon catalyst is left within the polymer matrix, resulting in the formation of a reinforced polymer composite, or is removed to afford the pure homopolymer or copolymer.

### EXAMPLES

The present invention may be better understood through reference to the following examples. These examples are included to describe exemplary embodiments only and should not be interpreted to encompass the entire breadth of the invention.

### Example 1

### Preparation of Graphene Oxide or Graphite Oxide Catalyst

The graphene oxide or graphite oxide used in some experiments contained in these examples was prepared according to the following method. Others were prepared using the Staudenmaier method. Both methods resulted in a suitable catalyst.

A modified Hummers method was used to prepare the graphite oxide. A 100 mL reaction flask was charged with natural flake graphite (3.0 g; SP-1, Bay Carbon Inc. or Alfa Aesar [99%; 7-10 μm]), concentrated sulfuric acid (75 mL), and a stir bar, and then cooled on an ice bath. The flask was then slowly charged with KMnO₄ (9.0 g) over 2 h which afforded a dark colored mixture. The rate of addition was controlled carefully to prevent the temperature of the suspension from exceeding 20° C. After stirring at 0° C. for 1 h, the mixture was heated at 35° C. for 0.5 h. The flask was then cooled to room temperature and the reaction was quenched by pouring the mixture into 150 mL of ice water and stirred for 0.5 h at room temperature. The mixture was further diluted to 400 mL with water and treated with a 30% aqueous solution of hydrogen peroxide (7.5 mL). The resulting vibrant yellow mixture was then filtered and washed with an aqueous HCl solution (6.0 N) (800 mL) and water (4.0 L). The filtrate was monitored until the pH value was neutral and no precipitate was observed upon the addition of aqueous barium chloride or silver nitrate to the filtrate. The filtered solids were collected and dried under high vacuum to afford the desired product (5.1 g) as a dark brown powder. Spectral data matched literature values.

### Example 2

### Preparation of Graphite Oxide

A 100 mL reaction flask is charged with natural flake graphite (6.0 g; SP-1, Bay Carbon Inc. or Alfa Aesar [99%; 7-10 μm]), concentrated sulfuric acid (25 mL), K₂S₂O₈ (5 g), P₂O₅ (5 g), and a stir bar, and then the mixture is heated at 80° C. for 4.5 h. The mixture is then cooled to room temperature. Next, the mixture is diluted with water (1 L) and left undisturbed for a period of about 8-10 hours. The pretreated graphite is collected by filtration and washed with water (0.5 L). The precipitate is dried in air for 1 day and transferred to concentrated H₂SO₄ (230 mL). The mixture is then slowly charged with KMnO₄ (30 g) over 2 h, which affords a dark colored mixture. The rate of addition is carefully controlled to prevent the temperature of the suspension from exceeding 10° C. The mixture is stirred at 0° C. for 1 h. The mixture is then heated at 35° C. for 2 h. The flask is then cooled to room temperature and the reaction is quenched by pouring the mixture into 460 mL of ice water and stirred for 2 h at room temperature. The mixture is further diluted to 1.4 L with water and treated with a 30% aqueous solution of hydrogen peroxide (25 mL). The resulting vibrant yellow mixture is then filtered and washed with an aqueous HCl solution (10%) (2.5 L) and then with water. The filtrate is monitored until the pH value is neutral and no precipitate is observed upon the addition of aqueous barium chloride or silver nitrate to the filtrate. The filtered solids are collected and dried under high vacuum to provide a product (11 g) as a dark brown powder.

### Example 3

### Preparation of Graphite Oxide

A 250 mL reaction flask is charged with natural flake graphite (1.56 g; SP-1 Bay Carbon Inc. or Alfa Aesar [99%; 7-10 μm]), 50 mL of concentrated sulfuric acid, 25 mL fuming nitric acid, and a stir bar, and then cooled in an ice bath. The flask is then charged with NaClO₃ (3.25 g; note: in some cases NaClO₃ is preferable over KClO₃ due to the aqueous insolubility of KClO₄ that may form during the reaction) under stirring. Additional charges of NaClO₃ (3.25 g) are performed every hour for 11 consecutive hours per day. This procedure is repeated for 3 d. The resulting mixture is poured into 2 L deionized water. The heterogeneous dispersion is then filtered through a coarse fitted funnel or a nylon membrane filter (0.2 μm, Whatman) and the isolated material is washed with additional deionized water (3 L) and 6 N HCl (1 L). The filtered solids are collected and dried under high vacuum to provide a product (3.61 g) as a dark brown powder.

### Example 4

### Preparation of Graphene Oxide

A graphene substrate is provided in a reaction chamber. The substrate does not exhibit one or more FT-IR peaks at 3150 cm⁻¹, 1685 cm⁻¹, 1280 cm⁻¹ or 1140 cm⁻¹. Next, plasma excited species of oxygen are directed from a plasma generator into the reaction chamber and brought in contact with an exposed surface of the graphene substrate. The graphene substrate is exposed to the plasma excited species of oxygen until an FT-IR spectrum of the substrate shows one or more peaks at 3150 cm⁻¹, 1685 cm⁻¹, 1280 cm⁻¹ or 1140 cm⁻¹. The graphene substrate has a layer of graphene oxide on the exposed surface of the graphene substrate.

### Example 5

### Polymerization Using Graphene Oxide or Graphite Oxide

(A) Synthesis of Nylon 6

In a typical preparation, a vial is charged with graphene oxide or graphite oxide, ε-caprolactam, CHCl3 and a magnetic stir bar. The vial is then sealed with a Teflon-lined cap under ambient atmosphere and heated at 200° C. for 24 h. After the reaction is complete, the mixture is cooled to room temperature and washed with CH2Cl2. The filtrate is collected and the solvent is evaporated to obtain the crude product, which is then further purified by standard procedures.

(B) Synthesis of Nylon 6,6

In a typical preparation, a vial is charged with graphene oxide or graphite oxide, adipic acid, and hexamethylene diamine. CHCl₃ and a magnetic stir bar. The vial is then sealed with a Teflon-lined cap under ambient atmosphere and heated at 150° C. for 36 h. After the reaction is complete, the mixture is cooled to room temperature and washed with CH₂Cl₂. The filtrate is collected and the solvent is evaporated to obtain the crude product, which is then further purified by standard procedures.

### Example 6

### Dehydrative Polymerization

Poly(phenylene methylene) (PPM) is prepared by reacting benzyl alcohol or benzyl chloride with GO. The reaction provides a polymer composite product with improved mechanical and thermal properties.

General Procedure Used to Prepare the PPM-GO Composites.

A 30 mL vial was charged with benzyl alcohol (3.0 g), GO (0-10 wt %), concentrated H₂SO₄ (0.03 g), and a magnetic stir bar. Concentrated H₂SO₄ was not added to reactions containing greater than 7.5 wt % GO in the starting mixture. The vial was sealed with a Teflon-lined cap under ambient atmosphere and the resulting heterogeneous mixture was stirred (300 rpm) at room temperature for 1 h (relative humidity: 40-70%). The mixture was then heated to 200° C. under continuous stirring for 14 h (temperatures less than 200° C. or times less than 14 h were found to contain unreacted benzyl alcohol). The reaction was then cooled to room temperature, at which point the polymer melt solidified. The water produced during the reaction phase separated from the product, affording the polymer composite as a black solid (2.65 g).

Using dynamic mechanical analysis (DMA), the additive-free polymer was found to exhibit a softening point (Tₛ) at approximately 35° C. In the PPM composite prepared using 10 wt % GO, the corresponding Tₛ was measured at 48° C., indicating that the softening point of the polymer was enhanced upon incorporation into a carbon-filled composite. Consistent with previous results determined on related poly(p-xylylene)s, the additive-free PPM appeared to be thermally stable and exhibited an onset of decomposition (T_{d}) at 464° C. by thermogravimetric analysis (TGA). The onset of decomposition was perturbed only slightly when the additive was incorporated at various GO loadings (i.e., the T_{d} ranged from 445-463° C.). In all of the composites tested, the decompositions occurred in a single event, rather than step-wise, suggesting cooperative effects between the matrix and additive. Prior to the Tₛ, the additive-free polymer exhibited an elastic modulus (E′) of 40 MPa; however, the E′ increased to 915 MPa upon incorporation of 10 wt % GO in the starting mixture.

### Example 7

### Olefin Polymerizations

Poly(vinyl ether)s are prepared by reacting vinyl ether monomers (for example, ethyl vinyl ether, butyl vinyl ether, etc.) with GO. The reaction provides polymer composite products with improved mechanical properties

General Procedure Used to Prepare Poly(Butyl Vinyl Ether) (PBVE).

A 7.5 mL vial was charged with butyl vinyl ether (1.0 g), GO (0.1-5.0 wt %), and a magnetic stir bar. The vial was sealed with a Teflon-lined cap under ambient atmosphere and the resulting heterogeneous mixture was stirred (300 rpm) at 22° C. for 4 h. The polymer was isolated as an amber liquid with carbon particles heterogeneously dispersed throughout in quantitative yield, requiring no further purification.

As determined by DSC, the polymer exhibited a glass transition temperature (T_{g}) of −63° C., consistent with previous reports on PBVE. Thermal stability was also found in the TGA experiments, which revealed that the polymer-catalyst composite was highly stable, exhibiting a decomposition temperature (T_{d}) of 354° C. No changes in T_{g} or T_{d} were observed when the residual carbon catalyst was removed by trituration in tetrahydrofuran (THF).

When 2.5 wt % GO was mixed with butyl vinyl ether at 22° C., 97.8% of the monomer was converted to PBVE within 5 minutes, and the polymer obtained at this reaction time exhibited nearly the same molecular weight (Mₙ=5400) and polydispersity (PDI=10.37) as the product obtained after 14 h. After 4 h, no unreacted monomer was observed by ¹H NMR spectroscopy. Upon conclusion of the 4 h reaction period, a product of similar molecular weight and polydispersity was obtained (Mₙ=5100 Da and PDI=10.89).

No reaction was observed in the absence of GO, indicating that butyl vinyl ether did not self-polymerize under these conditions. Likewise, low monomer conversion (2.3%, as determined by ¹H NMR spectroscopy) and molecular weight (700 Da versus 5400 Da) were observed when 0.01 wt % GO was used. Conversion increased as the loading was increased to 0.1, 1.0, 2.5, or 5.0 wt %, but the molecular weight of the polymer decreased: a maximum Mₙ of 8100 Da was observed at 0.1 wt %, while a minimum of 5000 Da was observed at 5.0 wt %.

Consistent with the retention of catalytically active functional groups, the catalyst was able to be reused after recovery, without reactivation or further treatment. After 5 use-recovery cycles, monomer conversion dropped only 9.2% under the standard conditions (2.5 wt % catalyst, 22° C., neat, 4 h). The molecular weight of PBVE prepared using GO was found to increase and the PDI to decrease with catalyst reuse, consistent with a decrease in the quantity of acidic initiators per mass of carbon catalyst (i.e., a lower catalyst-to-monomer ratio).

### Example 8

### Olefin Polymerizations

Using the procedure described above, Poly(N-vinylcarbazole) is prepared by reacting N-vinylcarbazole with GO to provide a product with improved electronic properties.

N-vinylcarbazole, dissolved in a minimum of chloroform, polymerized rapidly and exothermically when GO (2.5 wt %) was added, very similar to the reaction of butyl vinyl ether with GO. After 4 h, no unreacted monomer was visible by NMR spectroscopy, and GPC revealed a molecular weight (Mₐ) of 1900 Da and an exceptionally broad PDI of 30.78.

### Example 9

### Olefin Polymerizations

Using the procedure described above, Poly(styrene) is prepared by reacting styrene with GO to provide a product with improved mechanical, thermal and electronic properties.

### Example 10

### Olefin Polymerizations

Using the procedure described above, Poly(styrenesulfonate) is prepared by reacting sodium 4-styrenesulfonate with GO to provide a product with improved electronic properties.

In contrast to many of the other monomers explored, this starting monomer is a solid salt at room temperature. Thus, the addition of solvent (deionized water) was necessary to facilitate interaction of the monomer and the carbocatalyst. A saturated aqueous solution of sodium 4-styrenesulfonate was prepared (approximately 180 mg mL⁻¹ in deionized water). A 0.1 mL aliquot of this solution was mixed with 0.9 mL of deionized water and 50 mg of GO. The mixture was heated at 100° C. for 12 h in a sealed vessel to polymerize the monomer. The reaction mixture was diluted to 10 mL with methanol after which the composite was recovered by vacuum filtration and washed with excess methanol (50 mL) to remove unreacted monomer. In order to ensure maximal reduction of the GO in the present composite, we subjected the recovered composite to thermal reduction by heating under vacuum at 175° C. for 24 h. No chemical reductants were utilized. The resulting composite was highly conductive (σ=1.93×10² S m⁻¹), indicating that efficient reduction had taken place. For comparison, a conductivity of only 2.59×10⁻³ S m⁻¹ was observed for a composite not subjected to thermal treatment, prepared under otherwise identical conditions.

Qualitatively, incorporation of PSS into the composite was confirmed by FT-IR spectroscopy, which revealed a diagnostic absorbance at 1203 cm⁻¹, as well as less intense absorbances at 1365 and 1713 cm⁻¹, attributable to the presence of sulfonate groups on the polymer.

### Example 11

### Ring Opening Polymerizations

Poly(caprolactone) (PCL) is prepared by reacting ε-caprolactone with GO to provide a product with improved mechanical, thermal and electronic properties.

General Procedure Used to Prepare the PCL-GO Composites.

A 30 mL vial was charged with ε-caprolactone (3.0 g), GO (2.5-20 wt %), and a magnetic stir bar. The vial was sealed with a Teflon-lined cap under ambient atmosphere and the resulting heterogeneous mixture was stirred (300 rpm) at 60° C. for 14 h. The reaction was then cooled to room temperature, at which point the polymer melt solidified. The polymer composite was isolated as a black solid in quantitative yield, requiring no further purification. The carbon and polymer were separated by dissolving the polymer in 30 mL of dichloromethane, followed by filtration and washing of the solid carbon with 3×30 mL with dichloromethane. Residual solvents were removed from both components under vacuum (10⁻³ Torr).

Although no side reactions were observed at loadings below 2.5 wt %, the conversion of the ε-caprolactone to PCL was incomplete (17% conversion at 1.0 wt % loading of GO; Mₙ=5.1 kDa, PDI=1.26), as determined by ¹H NMR spectroscopy. However, using loadings at or above 2.5 wt %, conversion of the monomer was uniformly quantitative. Upon dissolution of the polymer in THF and removal of the insoluble carbon material by filtration, the additive-free polymer was recovered in 91% yield by precipitation into deionized water followed by vacuum filtration recovery. The high yield of the recovered polymer indicated that the extent of covalent attachment of the polymer to the carbon material's surface was minimal (see below for further discussion of polymer attachment to the carbon surface). Confirming that GO's acidic surface functionality was the source of the polymerization behavior, no reaction was observed when no catalyst was used, or when graphite or chemically-reduced graphene oxide (CReGO) were substituted for GO under otherwise identical conditions (neat, 60° C., 14 h).

Although PCL is an insulating material, at high carbon loadings, the composites incorporating the partially reduced GO were found to be conductive. At 20 wt % GO (in the starting reaction mixture), the composite exhibited a conductivity of 1.55×10⁻³ S m⁻¹.

To further explore the aforementioned polymer composites, their thermomechanical properties were characterized using dynamic mechanical analysis (DMA). The elastic modulus (E′) of the 2.5 wt % composite was found to be 459±9 MPa, compared to 260±10 MPa measured for an additive-free homopolymer, at an oscillation amplitude of 50 μm and a frequency of 1 Hz. Sample failure was observed at the polymer's melting point (Tₘ) of 56.4° C. The composite also exhibited a decomposition temperature (T_{d}) of 379.8° C. The elastic moduli of the PCL composites were found to increase with GO loading until a maximum E′ of 1045±8 MPa was reached at 10 wt % loading. The Young's modulus, as determined by tensile testing performed on films of the materials, was also found to increase with GO loading. When 2.5 wt % GO was used in the initial mixture, the composite exhibited a Young's modulus of 304 MPa, as compared to 164 MPa in carbon additive-free PCL. Beyond 10 wt %, E′ dropped significantly. Indeed, the reaction mixture incorporating 20 wt % GO was found to be highly phase separated, due to the increased carbon content, and we reasoned that this led to the material's resulting poor mechanical properties. As a result, the stiffness of the composite decreased, compared to the composites prepared with lower loadings of GO. Collectively, the thermomechanical data suggested to us that the use of GO as a carbocatalyst resulted in the formation of carbon-reinforced composites which exhibited dramatically improved stiffness, compared to the additive-free homopolymer, while leaving the Tᵢₙ and T_{d} essentially unperturbed.

No identifiable reflections were observed in the powder X-ray diffraction patterns of any of the present PCL composites or the separated carbon material, indicating the carbon did not restack into well-defined aggregates. Likewise, TEM revealed no large, graphitized agglomerations within the amorphous PCL matrix. The carbon was well-dispersed within the polymer matrix and were observed both as individual entities and in small aggregates of a few particles.

### Example 12

### Ring Opening Polymerizations

Poly(valerolactone) (PVL) is prepared by reacting 6-valerolactone with GO to provide a product with improved mechanical, thermal and electronic properties.

General Procedure Used to Prepare the PVL-GO Composites.

A 30 mL vial was charged with 6-valerolactone (3.0 g), GO (2.5 wt %), and a magnetic stir bar. The vial was sealed with a Teflon-lined cap under ambient atmosphere and the resulting heterogeneous mixture was stirred (300 rpm) at 60° C. for 14 h. The reaction was then cooled to room temperature, at which point the crude mixture solidified. The carbon and polymer were separated by dissolving the polymer in 30 mL of tetrahydrofuran, followed by filtration and washing of the solid carbon with 3×30 mL with tetrahydrofuran. The polymer was then precipitated into deionized water to remove unreacted monomer, separated by vacuum filtration, and isolated as a white solid (2.6 g, 86%). Residual solvents were removed from both components under vacuum (10⁻³ Torr).

The polymer was recovered in 86.2% yield at a loading of 2.5 wt % GO and exhibited a melting point (Tₘ) of 56.5° C. TGA revealed a decomposition temperature (T_{d}) of 269.4° C., consistent with previously reported values for PVL. The molecular weight (Mₙ) of the isolated PVL was found to be 10.2 kDa (PDI=1.64), as determined by GPC. As the GO loading was increased to 5.0 or 10.0 wt % GO, the isolated yield of the polymer product remained approximately constant, though we did observe a slight increase in molecular weight and a slight decrease in PDI. δ-Valerolactone did not polymerize in the absence of GO under otherwise identical conditions (neat, 60° C., 14 h), or in the presence of weak acids (2.5 wt % glacial acetic acid). However, in the presence of stronger acids (2.5 wt % concentrated H₂SO₄), under otherwise identical conditions (neat, 60° C., 14 h), the lactone was able to be polymerized to a molecular weight (Mₐ) of 7.6 kDa (PDI=1.93) in 60.4% yield. The melting point (52.1° C.) and decomposition temperature (268.2° C.) of the PVL prepared using H₂SO₄ were consistent with the sample prepared using GO as the catalyst.

### Example 13

### Ring Opening Polymerizations

Poly(butyrolactone) is prepared by reacting β-butyrolactone with GO as described above to provide a product with improved mechanical, thermal and electronic properties.

### Example 14

### Ring Opening Polymerizations

Poly(caprolactam) is prepared by reacting ε-caprolactam with basified GO to provide a product with improved mechanical and electronic properties.

General Procedure Used to Prepare the Nylon 6-GO Composites.

A 30 mL vial was charged with ε-caprolactam (3.0 g), basified GO (basified-GO) (5.0 wt %), and a magnetic stir bar. The vial was purged with nitrogen and sealed with a Teflon-lined cap. The resulting heterogeneous mixture was stirred (300 rpm) at 300° C. for 14 h. The reaction was then cooled to room temperature, at which point the polymer melt solidified. The carbon and polymer were separated by dissolving the polymer in 30 mL of formic acid (88% aq.), followed by filtration and washing of the solid carbon with 3×30 mL with formic acid. Residual solvents were removed from both components under vacuum (10⁻³ Torr). The formic acid solution containing the polymer was precipitated into deionized water (1 L), recovered by vacuum filtration, and dried under vacuum, affording the target product as a white solid (2.4 g, 80%).

After reacting ε-caprolactam in the presence of basified-GO (2.5-10.0 wt %) for 14 h at 300° C., the polymer and unreacted monomer were dissolved in formic acid (88% aq.), followed by filtration to remove the residual carbon material. The filtrate was then precipitated into deionized water, affording the polymeric product in excellent yield (70.0% when 5.0 wt % basified-GO was used) after recovery by filtration.

The viscosity average molecular weight (Mᵥ) was determined via dilute solution viscometry (DSV) in formic acid (88% aq.), and was found to be between 14.8 and 15.1 kDa. The T_{d} of the separated polymer, measured by TGA, was found to be 409.2° C., consistent with the high thermal stability of aliphatic polyamides. At 10.0 wt % loading of basified-GO, the polymer was recovered in slightly reduced yield (60.6%) after precipitation and the molecular weight was reduced to a range of 13.2-13.5 kDa, as determined by DSV. Conversely, only low yields of polymer (<0.5%) were obtained at a loading of 2.5 wt % basified-GO.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A process for synthesis of a polymer, comprising:
(a) contacting monomers with a catalytically active carbocatalyst; and
(b) transforming the monomers with the aid of the catalytically active carbocatalyst to form a mixture of a polymer product and a spent or partially spent carbocatalyst.

2. The process of claim 1, wherein the catalytically active carbocatalyst is an oxidized form of graphite.

3. The process of claim 1, wherein the catalytically active carbocatalyst is graphene oxide or graphite oxide.

4. The process of claim 1, wherein the catalytically active carbocatalyst is an oxidized carbon-containing material.

5. The process of claim 1, wherein the catalytically active carbocatalyst is characterized by one or more FT-IR features at about 3150 cm-1, 1685 cm-1, 1280 cm-1, or 1140 cm-1.

6. The process of claim 1, wherein the catalytically active carbocatalyst is a heterogenous catalyst.

7.-9. (canceled)

10. The process of claim 1, wherein the catalytically active carbocatalyst is present on a solid support.

11. (canceled)

12. The process of claim 1, wherein the catalytically active carbocatalyst has a plurality of functional groups selected from a hydroxyl group, an alkyl group, an alkenyl group, an alkynyl group, an aryl group, epoxide group, peroxide group, peroxyacid group, aldehyde group, ketone group, ether group, carboxylic acid or carboxylate group, peroxide or hydroperoxide group, lactone group, thiolactone, lactam, thiolactam, quinone group, anhydride group, ester group, carbonate group, acetal group, hemiacetal group, ketal group, hemiketal group, amino, aminohydroxy, aminal, hemiaminal, carbamate, isocyanate, isothiocyanate, cyanamide, hydrazine, hydrazide, carbodiimide, oxime, oxime ether, N-heterocycle, N-oxide, hydroxylamine, hydrazine, semicarbazone, thiosemicarbazone, urea, isourea, thiourea, isothiourea, enamine, enol ether, aliphatic, aromatic, phenolic, thiol, thioether, thioester, dithioester, disulfide, sulfoxide, sulfone, sultone, sulfinic acid, sulfenic acid, sulfenic ester, sulfonic acid, sulfite, sulfate, sulfonate, sulfonamide, sulfonyl halide, thiocyanate, thiol, thial, S-heterocycle, silyl, trimethylsilyl, phosphine, phosphate, phosphoric acid amide, thiophosphate, thiophosphoric acid amide, phosphonate, phosphinite, phosphite, phosphate ester, phosphonate diester, phosphine oxide, amine, imine, amide, aliphatic amide, aromatic amide, halogen, chloro, iodo, fluoro, bromo, acyl halide, acyl fluoride, acyl chloride, acyl bromide, acyl iodide, acyl cyanide, acyl azide, ketene, alpha-beta unsaturated ester, alpha-beta unsaturated ketone, alpha-beta unsaturated aldehyde, anhydride, azide, diazo, diazonium, nitrate, nitrate ester, nitroso, nitrile, nitrite, orthoester group, orthocarbonate ester group, O-heterocycle, borane, boronic acid, boronic ester.

13. The process of claim 1, wherein the conversion is catalytic or stoichiometric with respect to the amount of catalytically active carbocatalyst.

14. The process of claim 1, wherein the process further comprises contacting the monomers with a co-catalyst.

15.-28. (canceled)

29. The process of claim 1, wherein the polymer product is further purified to obtain a polymer product which is substantially free of the spent carbocatalyst or partially spent carbocatalyst.

30. The process of claim 1, wherein the polymer product is a polymer composite.

31. The process of claim 30, wherein the polymer composite comprises spent carbocatalyst or partially spent carbocatalyst.

32. The process of claim 31, wherein the polymer composite is further compounded with one or more additional additives.

33. The process of claim 32, wherein the additional additive is metastable graphene, unreacted monomer, a separate pre-formed polymer or a separate composite, or a combination thereof.

34. (canceled)

35. (canceled)

36. A polymer made by the process of claim 1.

37. The polymer of claim 36, wherein the polymer is a polyester, a polyamide, a polyolefin, a polyurethane, a polysiloxane, an epoxy, or a polycarbonate.

38. A polymer composite made by the process of claim 1.

39. The polymer composite of claim 38, wherein the polymer composite comprises a polymer selected from a polyester, a polyamide, a polyolefin, a polyurethane, a polysiloxane, an epoxy, and a polycarbonate.

40. The process of claim 1, wherein the polymer is formed by condensation polymerization, addition polymerization, olefin polymerization, ring opening polymerization, cationic polymerization, acid-catalyzed polymerization, or combinations thereof.
